(19) United States
(12) Patent Application Publication
(10) Pub. No.: US 2026/0230264 A1
(43) Pub. Date: Aug. 6, 2026

(54) TERMINAL, RADIO COMMUNICATION METHOD, AND BASE STATION

(71) Applicant: NTT DOCOMO, INC., Tokyo (JP)

(72) Inventors: Naoya SHIBAIKE, Tokyo (JP); Yuki MATSUMURA, Tokyo (JP); Satoshi NAGATA, Tokyo (JP); Jing WANG, Beijing (CN)

(73) Assignee: NTT DOCOMO, INC., Tokyo (JP)

(21) Appl. No.: 19/152,047

(22) PCT Filed: Feb. 1, 2023
(86) PCT No.: PCT/JP2023/003186

§ 371 Date: Jul. 30, 2025

(51) Int. Cl. H04L 5/00

(52) U.S. Cl. CPC H04L 5/0051

(57) ABSTRACT

A terminal according to one aspect of the present disclosure includes a receiving section that receives a configuration of one or more non-zero power (NZP) CSI-reference signal (RS) resource sets for Doppler channel state information (CSI), and a control section that determines, based on the configuration, a plurality of periodic or semi-persistent CSI-RS occasions. One aspect of the present disclosure allows CSI to be appropriately reported.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (Non-Patent Literature 1). In addition, for the purpose of further high capacity, advancement and the like of the LTE (Third Generation Partnership Project (3GPP (registered trademark)) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), reporting of channel state information (CSI) based on reference signal reception is under study. Enhancement of communication performance in a terminal (a user terminal, a User Equipment (UE)) that moves at high/middle speed is under study.

Meanwhile, studies have not sufficiently been made on CSI/codebook in such a terminal. Unless such a method is defined clearly, communication throughput, communication quality, and the like may deteriorate.

In view of this, an object of the present disclosure is to provide a terminal, a radio communication method, and a base station that determine appropriate CSI/codebook.

### Solution to Problem

A terminal according to one aspect of the present disclosure includes a receiving section that receives a configuration of one or more non-zero power (NZP) CSI-reference signal (RS) resource sets for Doppler channel state information (CSI), and a control section that determines, based on the configuration, a plurality of periodic or semi-persistent CSI-RS occasions.

### Advantageous Effects of Invention

One aspect of the present disclosure allows CSI to be appropriately reported.

### BRIEF DESCRIPTION OF DRAWINGS

FIG. 1 shows an example of a 16-level quantization table.

FIG. 2 shows an example of an 8-level quantization table.

FIGS. 3A and 3B show examples of an enhanced type 2 port selection codebook.

FIGS. 4A and 4B show examples of an enhanced type 2 port selection codebook.

FIG. 5 shows an example of a parameter combination for a Rel-16 type 2 codebook.

FIG. 6 shows an example of a parameter combination for a Rel-17 type 2 port selection codebook.

FIG. 7 shows an example of configuration of a CSI-RS resource and a CSI report.

FIG. 8 shows an example of a timing of measurement/reporting of Doppler CSI.

FIG. 9 shows an example of a timing of measurement/reporting of Rel-17 type 2 CSI.

FIG. 10 shows an example of CMR configuration according to Embodiment #1-1a.

FIG. 11 shows an example of CMR configuration according to Embodiment #1-3.

FIG. 12 shows an example of a CMR in Rel. 17 (or earlier versions).

FIG. 13 shows an example of an issue in type 2 Doppler CSI.

FIG. 14 shows an example of configuration of a plurality of NZP CSI-RS resource sets.

FIG. 15 shows an example of CMR configuration according to Embodiment #3-1.

FIG. 16 shows an example of a plurality of NZP CSI-RS occasions according to Embodiment #3-1-3/#3-1-4.

FIG. 17 is a diagram to show an example of a schematic structure of a radio communication system according to one embodiment.

FIG. 18 is a diagram to show an example of a structure of a base station according to one embodiment.

FIG. 19 is a diagram to show an example of a structure of a user terminal according to one embodiment.

FIG. 20 is a diagram to show an example of a hardware structure of the base station and the user terminal according to one embodiment.

FIG. 21 is a diagram to show an example of a vehicle according to one embodiment.

### DESCRIPTION OF EMBODIMENTS

### (CSI Report (or Reporting))

In Rel-15 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non-zero power (NZP) CSI-RS and CSI-Interference Management (CSI-InterferenceMeasurement, CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information related to a CSI report (report configuration information), and may control, based on the report configuration information, CSI reporting. The report configuration information may be, for example, an information element (IE) “CSI-ReportConfig” of radio resource control (RRC). Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an RRC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report

For example, the report type information may indicate a periodic CSI (P-CSI) report, an aperiodic CSI (A-CSI) report, or a semi-persistent (semi-permanent) CSI (SP-CSI) report.

The report quantity information may indicate at least one combination of the above CSI parameters (for example, CRI, RI, PMI, CQI, LI, L1-RSRP, and the like).

The resource information may be an ID of the resource for the RS. The resource for the RS may include, for example, a non-zero power CSI-RS resource or SSB, and a CSI-IM resource (for example, a zero power CSI-RS resource).

The frequency domain information may indicate frequency granularity of the CSI report. The frequency granularity may include, for example, a wideband and a subband. The wideband is the entire CSI reporting band. For example, the wideband may be the entire certain carrier (component carrier (CC), cell, serving cell), or may be the entire bandwidth part (BWP) in a certain carrier. The wideband may be interpreted as CSI reporting band, the entire CSI reporting band, and the like.

The subband may be part of the wideband and constituted of one or more resource blocks (RBs or physical resource blocks (PRBs)). The size of the subband may be determined according to the size of the BWP (the number of PRBs).

The frequency domain information may indicate a PMI of which of the wideband or the subband is to be reported (frequency domain information may include, for example, an RRC IE “pmi-FormatIndicator” used for determination of one of wideband PMI reporting and subband PMI reporting). The UE may determine, based on at least one of the report quantity information and the frequency domain information, frequency granularity of the CSI report (that is, one of the wideband PMI report and the subband PMI report).

When the wideband PMI report is configured (determined), one wideband PMI may be reported for the entire CSI reporting band. On the other hand, when the subband PMI report is configured, single wideband indication iᵢ may be reported for the entire CSI reporting band, and subband indication (one subband indication) i₂ for each of one or more subbands in the entire CSI reporting (for example, subband indication for each subband) may be reported.

The UE performs channel estimation by using a received RS to estimate a channel matrix H. The UE feeds back an index (PMI) determined based on the estimated channel matrix.

The PMI may indicate a precoder matrix (also simply referred to as a precoder) that the UE considers appropriate for the use for downlink (DL) transmission to the UE. Each value of the PMI may correspond to one precoder matrix. A set of values of the PMI may correspond to a different set of precoder matrices referred to as a precoder codebook (also simply referred to as a codebook).

In the spatial domain (space domain), the CSI report may include CSI of one or more types. For example, the CSI may include at least one of a first type (type 1 CSI) used for selection of a single beam, and a second type (type 2 CSI) used for selection of multi-beam. The single beam may be interpreted as a single layer, and the multi-beam may be interpreted as a plurality of beams. The type 1 CSI may not assume multi-user multiple input multiple output (MU-MIMO), and the type 2 CSI may assume multi-user MIMO.

The above codebook may include a codebook for the type 1 CSI (also referred to as a type 1 codebook or the like) and a codebook for the type 2 CSI (also referred to as a type 2 codebook or the like). The type 1 CSI may include type 1 single-panel CSI and type 1 multi-panel CSI, and different codebooks (type 1 single-panel codebook, type 1 multi-panel codebook) may be defined.

In the present disclosure, Type 1 and Type I may be interchangeably interpreted. In the present disclosure, Type 2 and Type II may be interchangeably interpreted.

An uplink control information (UCI) type may include at least one of a Hybrid Automatic Repeat reQuest ACKnowledgement (HARQ-ACK), a scheduling request (SR), and CSI. UCI may be delivered on a PUCCH, or may be delivered on a PUSCH.

In Rel-15 NR, the UCI can include one CSI part for wideband PMI feedback. CSI report #n includes, if reported, PMI wideband information.

In Rel-15 NR, the UCI can include two CSI parts for subband PMI feedback. CSI part 1 includes wideband PMI information. CSI part 2 includes one piece of wideband PMI information and some pieces of subband PMI information. CSI part 1 and CSI part 2 are separately coded.

In Rel-15 NR, the UE is configured with N (N≥1) report settings for CSI report configuration and M (M≥1) resource settings for CSI resource configuration, by a higher layer. For example, the CSI report configuration (CSI-ReportConfig) includes a resource setting for channel measurement (resourcesForChannelMeasurement), a CSI-IM resource setting for interference (csi-IM-ResourceForInterference), an NZP-CSI-RS setting for interference (nzp-CSI-RS-ResourceForInterference), a report quantity (reportQuantity), and the like. Each of the resource setting for channel measurement, the CSI-IM resource setting for interference, and the NZP-CSI-RS setting for interference is associated with a CSI resource configuration (CSI-ResourceConfig, CSI-ResourceConfigId). The CSI resource configuration includes a list of CSI-RS resource sets (csi-RS-ResourceSetList, for example, NZP-CSI-RS resource set or CSI-IM resource set).

For enabling, for both of FR1 and FR2, more dynamic channel/interference hypotheses for NCJT, assessment and specifications of CSI reporting for DL transmission with at least one of multi-TRP and multi-panel are under study.

### (Codebook Configuration)

The UE is configured with a codebook-related parameter (codebook configuration (CodebookConfig)) by higher layer signaling (RRC signaling). The codebook configuration is included in a CSI report configuration (CSI-ReportConfig) of a higher layer (RRC) parameter.

In the codebook configuration, at least one codebook of a plurality of codebooks including a type 1 single panel (typeI-SinglePanel), type 1 multi-panel (typeI-MultiPanel), type 2 (typeII), and type 2 port selection (typeII-PortSelection) is selected.

The codebook parameter includes a parameter related to codebook subset restriction (CBSR) ( . . . Restriction). Configuration of the CBSR is a bit indicating, for a precoder associated with a CBSR bit, which PMI report is allowed (“1”) and which PMI report is not allowed (“0”). 1 bit of a CBSR bitmap corresponds to one codebook index/antenna port.

### (CSI Report Configuration)

CSI report configuration (CSI-ReportConfig) of Rel. 16 includes CSI-RS resources for channel measurement (resourcesForChannelMeasurement (CMRs)), CSI-RS resources for interference measurement (csi-IM-ResourcesForInterference (ZP-IMRs), nzp-CSI-RS-ResourcesForInterference (NZP-IMRs)), and the like, in addition to a codebook configuration (CodebookConfig). The parameters of CSI-ReportConfig excluding codebookConfig-r16 are also included in CSI report configuration of Rel. 15.

For Rel. 17, enhanced CSI report configuration (CSI-ReportConfig) for multi-TRP CSI measurement/reporting using NCJT is under study. In the CSI report configuration, two CMR groups corresponding to two respective TRPs are configured. CMRs in the CMR groups may be used for measurement of at least one of multi-TRP using NCJT and a single TRP. N CMR pairs for NCJT are configured by RRC signaling. Whether CMRs of a CMR pair are to be used for single TRP measurement may be configured for the UE by RRC signaling.

For CSI reporting associated with multi-TRP/panel NCJT measurement and configured by a single CSI report configuration, support of at least one of Options 1 and 2 below is under study.

### <Option 1>

The UE is configured to report X (X=0, 1, 2) pieces of CSI associated with single TRP measurement hypotheses and one piece of CSI associated with NCJT measurement. When X=2, two pieces of CSI are associated with two different single TRP measurements using CMRs of different CMR groups.

### <Option 2>

The UE may be configured to report one piece of CSI associated with the best measurement result of measurement hypotheses for NCJT and a single TRP.

As described above, in Rel. 15/16, CBSR is configured for each codebook configuration for each CSI report configuration. In other words, the CBSR is applied to all the CMRs and the like in corresponding CSI reporting configuration.

Note, however, that there is a possibility that when the Options 1 and 2 above are applied to multi-TRP CSI report configuration of Rel. 17 by CSI report configuration, configuration of the following measurement is performed.
Option 1 (X=0): measurement of only CSI for NCJT 1Option 1 (X=1): measurement of CSI for NCJT and CSI for single TRP (one TRP)
Option 1 (X=2): measurement of CSI for NCJT and CSI for single TRP (two TRPs)
Option 2: measurement of both of CSI for NCJT and CSI for single TRP

A plurality of subbands for given CSI part #n indicated by a higher layer parameter “csi-ReportingBand” may be numbered continuously in increasing order to include, as subband 0, the lowest subband of csi-ReportingBand.

### (Type 1 Codebook)

As type 1 codebooks (Rel. 15), a type 1 single-panel codebook and a type 1 multi-panel codebook are defined for a base station panel. In a type 1 single panel, an antenna model of a CSI antenna port array (logical configuration) is defined for (N1, N2). The number P_{CSI-RS} of CSI-RS antenna ports is 2N₁N₂. In type 1 multi-panel, an antenna model of a CSI antenna port array (logical configuration) is defined for the number P_{CSI-RS} of CSI-RS antenna ports and (N_{g}, N₁, N₂).

For Rel-15 type 1 single-panel CSI, a higher layer parameter of a codebook type (subType in typel in codebookType in CodebookConfig) is set to a type 1 single panel (‘typeI-SinglePanel’) for the UE. The number v of layers ∈{2, 3, 4} is not satisfied, PMI values correspond to three codebook indices i_{1,1}, i_{1,2}, i₂. The number v of layers ∈{2, 3, 4} is satisfied, PMI values correspond to four codebook indices i_{1,1}, i_{1,2}, i_{1,3}, i₂. The number v of layers ∈{2, 3, 4} is not satisfied, composite codebook index i₁=[i_{1,1}, i_{1,2}]. The number v of layers ∈{2, 3, 4} is satisfied, composite codebook index i₁=[i_{1,1}, i_{1,2}, i_{1,3}]. i₁ may be an index for a wide band. i₂=n may be an index for a subband/phase.

For P_{CSI-RS}, supported configurations (value combinations) of (N₁, N₂) and (O₁, O₂) are defined in a specification. (N₁, N₂) indicates the number of two-dimensional (2D) antenna elements, and is configured by a higher layer parameter “n1-n2” in moreThanTwo in nrOfAntennaPorts in typeI-SinglePanel. “n1-n2” is an N₁O₁N₂O₂-bit bitmap parameter. (O₁, O₂) is a 2D oversampling factor.

In a codebook for 1-layer CSI reporting and codebookMode=1, index i_{1,1} corresponding to a horizontal beam=1=0, 1, . . . , N₁O₁-1, i_{1,2} corresponding to a vertical beam=m=0, 1, . . . , N₂O₂-1, i₂=n=0, 1, 2, 3, and a matrix for the 1-layer CSI reporting codebook using antenna ports 3000 to 2999+P_{CSI-RS} is W_i_{1,1}, i_{1,2}, i₂ \hat{ }(1). Here, W_{l,m,n}⁽¹⁾ is given by the following equation.

$${W}_{l , m , n}^{( 1 )} = \frac{1}{\sqrt{{P}_{CSI - RS}}} [ \begin{matrix}{v}_{l , m} \\ {φ}_{n} {v}_{l , m}\end{matrix} ] \qquad ( E1 )$$

Here, v_{1,m} is an element (SD base) of a 2D-SD (DFT) base vector having N₁ rows and N₂ columns (matrix, exp(j2π ln₁/O₁N₁)×exp(j2πmn₂/O₂N₂), n₁=0, 1, . . . , N₁-1, n₂=0, 1, . . . , N₂−1). Co-phasing between polarizations (horizontal polarization and vertical polarization) φₙ=exp(jπn/2), and indicates a phase of one polarization relative to a phase of the other polarization.

For Rel-15 type 1 multi-panel CSI, as compared with that for the type 1 single panel, the number N_{g} of panels is configured in addition to N₁, N₂. As inter-panel co-phasing (phase compensation between panels), i,_{1,4} is added and reported. The same SD beam (precoding matrix W₁) is selected for each panel, and only inter-panel co-phasing is additionally reported.

For P_{CSI-RS}, supported configurations (value combinations) of (N_{g}, N₁, N₂) and (O₁, O₂) are defined in a specification. (N₁, N₂) is configured by ng-n1-n2 in typeI-MultiPanel. i_{1,1} is {0, 1, . . . , N₁O₁−1}. i_{1,2} is {0, 1, . . . , N₂O₂−1}. For q=1, . . . , N_{g}−1, i_{1,4,q} is {0, 1, 2, 3}. i₂ is {0, 1, 2, 3}. For codebookMode=1, a matrix for a 1-layer CSI report codebook using antenna ports 3000 to 2999+P_{CSI-RS} is W_i_{1,1}, i_{1,2}, i_{1,4}, i₂ \hat{ }(1). Here, W_{l,m,p,n}⁽¹⁾=W_{l,m,p,n}\hat{ }1,N_{g}, 1.

W_l,m,p,n\hat{ },N_{g}, 1 and W_l,m,p,n \hat{ }2,N_{g},1 for N_{g}={2, 4}(matrix W_{l,m,p,n}^{l,2,1} for the first layer, N_{g}=2, codeBookMode=1, matrix W_{l,m,p,n}^{2,2,1} for the second layer, N_{g}=2, codeBookMode=1, matrix W_{l,m,p,n}^{1,4,1} for the first layer, N_{g}=4, codeBookMode=1, and matrix W_{l,m,p,n}^{2,4,1} for the second layer, N_{g}=4, codeBookMode=1) are given by the following equations.

$${W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] \qquad ( E2 )$$

$${W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ]$$

$${W}_{l , m , p , n}^{1 , 4 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ]$$

$${W}_{l , m , p , n}^{2 , 4 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ]$$

Here, φₙ=e^{jπn/2}. For N_{g}=2, p=p₁, and for N_{g}=4, p=[p₁, p₂, p₃]. φ_p₁, φ_p₂, and φ_p₃ indicate inter-panel co-phasing. The same beam (SD beam matrix, precoding matrix Wi) is selected for panels 0, 1, 2, and 3, and φ_p₁, φ_p₂, and φ_p₃ indicate phase compensation for panel 1, phase compensation for panel 2, and phase compensation for panel 3 relative to panel 0, respectively.

### (Type 2 Codebook)

In the present disclosure, matrix Z with X rows and Y columns is sometimes expressed as Z(X×Y).

For type 2 CSI of Rel. 15, generation of per-subband (SB-wise) precoding vectors is based on the following equation for given layer l.

$${W}_{1} ( {N}_{t} \times {N}_{3} ) = {W}_{1} {W}_{2 , 1} \qquad ( F1 )$$

Nₜ is the number of antennas/antenna ports. N₃ is a total number of precoding (beamforming) matrices (precoders) (number of subbands) indicated by a PMI. W₁(Nₜ×2L) is L∈{2, 4}(oversampled) spatial domain (SD) vectors (SD 2D-DFT vectors, SD beams, SD matrices). L is the number of beams. The actual number of beams taking account of a horizontal polarization and a vertical polarization at one point is 2L. For example, L=2 SD 2D-DFT vectors are bᵢ and bⱼ. W_{2,1} (2L×N₃) is a matrix (LC coefficient matrix) formed by linear combination (LC) coefficients (subband complex LC coefficients, combination coefficients) for layer l. W_{2,1} indicates beam selection and co-phasing between two polarizations. For example, two W_{2,1} are cᵢ and cⱼ. For example, channel vector h is approximated by linear combination of L=2 SD 2D-DFT vectors cᵢbᵢ, +cⱼbⱼ. Feedback overhead is primarily caused by LC coefficient matrix W_{2,1}. The type 2 CSI of Rel. 15 supports only ranks 1 and 2.

In the type 2 CSI, a channel (channel matrix) for a certain user is indicated by two polarizations and linear combination of L beams (L SD 2D-DFT vectors). The type 2 CSI of Rel. 15 supports ranks 1 and 2.

### (Enhancement of Type 2 Codebook (Rel. 16))

Type 2 CSI of Rel. 16 (enhanced type 2 codebook) reduces overhead related to W_{2,1} by using frequency domain (FD) compression. The type 2 CSI of Rel. 16 supports ranks 3 and 4 in addition to ranks 1 and 2.

In the type 2 CSI of Rel. 16, information based on the following equation is reported by the UE for given layer 1.

$${W}_{1} = {W}_{1} {W}_{1}^{\sim} {W}_{f , {1}^{H}} \qquad ( F2 )$$

W_{2,1} is approximated by W^{~}ₗW_{f,l}^{H}. Matrix W^{~} may be expressed by adding~ to the top of W (tilde on w). W^{~}ₗ may be expressed as W^{~}_{2,1}. Matrix W_{f,l}^{H} is an adjoint matrix of W_{f,l}, and is obtained by conjugate transposition of W_{f,l}.

For a CSI report, the UE may be configured with one of two subband sizes. The subband (CQI subband) may be defined as N_{PRB}^{SB} consecutive PRBs, and may depend on a total number of PRBs in a BWP. The number R of PMI subbands per CQI subband is configured by an RRC IE (numberOfPMI-SubbandsPerCQI-Subband). R controls a total number N₃ of precoding matrices indicated by a PMI, as a function of the number of subbands configured in csi-ReportingBand, a subband size configured by subbandSize, and a total number of PRBs in a BWP.

W₁(Nₜ×2L) is a plurality of (oversampled) SD 2D-DFT vectors (matrices). For indication of this matrix, a plurality of indices of SD 2D-DFT vectors and a two-dimensional over-sampling factor are reported. Response/distribution of a spatial domain indicated by an SD 2D-DFT vector may be referred to as an SD beam.

W^{~}₁(2L×Mᵥ) is a matrix formed by an LC coefficient. For indication of this matrix, up to K₀ non-zero coefficients (NZCs, non-zero amplitude LC coefficients) are reported. The report is formed by two parts: a bitmap for identifying an NZC location, and a quantized NZC.

W_{f,l}(N₃×Mᵥ) is a matrix formed by a plurality of frequency domain (FD) bases (vectors) for layer l. N₃ is a total number of precoding (beamforming) matrices (precoders) (number of subbands) indicated by a PMI, as a function of the number of subbands configured in csi-ReportingBand. csi-ReportingBand indicates consecutive or non-consecutive subbands in a certain BWP in a case where CSI for the BWP is reported. Mᵥ FD base (FD DFT base) vectors are present for each layer. When N₃>19, Mᵥ FD bases from an intermediate subset (InS) of size N₃′ (<N₃) are selected. When N₃≤19, log₂ (C(N₃−1, Mᵥ−1)) bits are reported. Here, C (N₃−1, Mᵥ−1) indicates the number of combinations to select Mᵥ−1 from N₃−1 (combinatorial coefficient C(x, y)), and is also referred to as binomial coefficients.

Response/distribution (frequency response) of a frequency domain indicated by an FD base vector and linear combination of LC coefficients may be referred to as an FD beam. The FD beam may correspond to a delay profile (time response).

A PMI subband size is given by a CQI subband size/R, and R∈{1, 2}. The number Mᵥ of FD base vectors for given rank v is given by ceil(pᵥ×N₃/R). The number of FD bases is the same for all the layers l∈{1, 2, 3, 4}. pᵥ is configured by a higher layer.

A plurality of precoding matrices indicated by a PMI are determined based on L+Mᵥ vectors.

Elements (SD bases) of L SD base vectors for beam index i=0, 1, . . . , L−1 v_{m_1\hat{ }(i), m_2\hat{ }(i)} are identified by q₁, q₂, n₁, n₂, and indicated by i_{1,1}, i_{1,2}.

The Mᵥ FD base vectors are identified by Mᵢₙᵢₜᵢₐₗ∈{−2Mᵥ+1, −2Mᵥ+2, . . . , 0}, n_{3,1}=[n_{3,1}⁽⁰⁾, . . . , n_{3,1}^{(M_v-1)}], and n_{3,1}^{(f)}∈{0, 1, . . . , N₃−1}.

An element (FD base) of an FD base vector for index t=0, 1, . . . , N₃−1 and layer l=1, . . . , v associated with a precoding matrix (subband) is y_{t,1}^{(f)}=exp(j2πtn_{3,1}^{(f)}/N₃). In the Mᵥ FD base vectors, an FD base vector for index f=0, 1, . . . , Mᵥ−1 associated with the FD base vector is [y_{0,1}^{(f)}, y_{1,1}^{(f)}, . . . , y_{N_3-1,1}^{(f)}]^{T}.

Each row of matrix W_{2,1} indicates channel frequency response of a specific SD beam. When the SD beam has high directivity, a channel tap per beam is limited (power delay profile becomes sparse in the time domain). As a result, channel frequency response for each SD beam has high correlation (becomes close to a flat form in the frequency domain). In this case, the channel frequency response can be approximated by linear combination of a small number of FD base vectors. For example, when Mᵥ=2, by using FD bases f₂, f_{q} and LC coefficients d₁⁰, d₂⁰, frequency response associated with SD beam be is approximated by d₁⁰f₂+, d₂⁰ f_{q}.

Dominant Mᵥ FD base vectors are selected. With Mᵥ<<N₃, overhead of W^{~}₁ is much smaller than overhead of W_{2,1}. All or some of the Mᵥ FD base vectors are used to approximate frequency response of each SD beam. A bitmap is used to report only an FD base vector selected for each SD beam. If no bitmap is reported, all the FD base vectors are selected for each SD beam. In this case, NZCs of all the FD base vectors are reported for each SD beam. The number of NZCs in one layer K₁^{NZ}≤K₀=ceil(β×2LMᵥ), and the number of NZCs over all the layers K^{NZ}≤2K₀=ceil(β×2LMᵥ). β is configured by a higher layer.

In the Rel-16 (enhanced) type 2 codebook, values of L, β, and pᵥ (parameter combination) are determined by a higher layer parameter “paramCombination-r16” (codebook parameter configuration).

Type 2 CSI feedback on a PUSCH in Rel. 16 includes two parts. CSI part 1 has a fixed payload size, and is used to identify the number of information bits in CSI part 2. A size of part 2 is variable (UCI size depends on the number of NZCs that is not recognized by the base station). In CSI part 1, the UE reports the number of NZCs that determines the size of CSI part 2. After receiving CSI part 1, the base station recognizes the size of CSI part 2.

In enhanced type 2 CSI feedback, CSI part 1 includes an RI (if reported), a CQI, and an indicator of a total number of non-zero amplitude coefficients over a plurality of layers for enhanced type 2 CSI. The RI (if reported), the CQI, and the indicator of the total number of non-zero amplitude coefficients over the plurality of layers, as fields of part 1, are separately coded. CSI part 2 includes a PMI of enhanced type 2 CSI. Parts 1 and 2 are separately coded. CSI part 2 (PMI) includes at least one of an oversampling factor, an index of an SD (2D-DFT) base, an index Mᵢₙᵢₜᵢₐₗ of an initial FD (DFT) base vector (start offset) of a selected DFT window, an FD base selected for each layer, an NZC (amplitude and phase) per layer, a strongest (maximum strength, strongest amplitude) coefficient indicator (SCI) per layer, and amplitude of the strongest coefficient per layer/per polarization.

A plurality of PMI indices (PMI values, codebook indices) associated with different pieces of CSI part 2 information may follow the following for the l-th layer.
i_{1,1}: two-dimensional oversampling factor [q1, q2]q₁∈{0, 1, . . . , O₁−1}, q₂ ∈{0, 1, . . . , O₂−1}.
i_{1,2}: plurality of indices of SD 2D-DFT bases (SD beams) i_{1,2} ∈{0, 1, . . . , C(N₁N₂, L)−1}.
i_{1,5}: codebook indicator An index of an FD DFT base of the selected DFT window. i_{1,5} ∈{0, 1, . . . , 2Mᵥ−1}.
i_{1,6,1}: codebook indicator An FD DFT base selected for the l-th layer. When N₃≤19, i_{1, 6,1} ∈{0, 1, . . . , C (N₃−1, Mᵥ−1)−1}. When N₃>19, i_{1,6,1} ∈{0, 1, . . . , C(2Mᵥ−1, Mᵥ−1)−1}.
i_{1,7,1}: bitmap indicator for l-th layer A non-zero bit in the bitmap identifies which coefficient of i_{2,4,1} and i_{2,5,1} is reported. i_{1,7,1}=[k_{1,0}⁽³⁾ . . . k_{1,M_-1}⁽³⁾], k_{1,f}⁽³⁾=[k_{1,0,f}⁽³⁾ . . . k_{1, M_v-1, f}⁽³⁾], and k_{1,i,f}⁽³⁾∈{0, 1}.
i_{1,8,1}: strongest coefficient indicator for 1-th layer (maximum element k_{1,i,f}⁽²⁾ in amplitude coefficient indicator)
i_{2,3,1}: amplitude coefficient indicator of coefficient (wide band) for l-th layer (for both polarizations) i_{2,3,1}=[k_{1,0}⁽¹⁾, k_{1,1}⁽¹⁾].
i_{2,4,1}: amplitude coefficient indicator of reported coefficient (subband) for l-th layer i_{2,3,1}=[k_{1,0}⁽²⁾, . . . , k_{1,M_v-1}⁽²⁾].
i_{2,5,1}: phase coefficient indicator of reported coefficient (subband) for l-th layer i_{2,5,1}=[c_{1,0,f}, . . . , c_{1,M_v-1,f}].

Assume that f₁*∈{0, 1, . . . , Mᵥ−1} and i₁*∈{0, 1, . . . , 2L−1} are an index of i_{2,4,1} and an index of k_{1,f_l\hat{ }*}⁽²⁾, respectively. These f₁* and i₁* identify the strongest coefficient for layer l=1, . . . , v, that is, an element k_{1,i_1\hat{ }*,f_1\hat{ }*}⁽²⁾ of i_{2,4,1} for layer l. A codebook index n_{3,1} is remapped as n_{3,1}^{(f)}=(n_{3,1}^{(f)}−n_{3,1}^{(f_l\hat{ }*)}) mod N₃, for n_{3,1}^{(f_1\hat{ }*)}. After the remapping, n_{3,1}^{(f_1\hat{ }*)}=0. An index f is remapped as f=(f−f₁*) mod Mᵥ, for f₁*. After the remapping, f₁*=0 (1=1, . . . , v). i_{2,4,1}, i_{2,5,1}, and i_{1,7,1} indicate an amplitude coefficient, a phase coefficient, and a bitmap after the remappings, respectively. The strongest coefficient for layer l identified by i_{1,8,1} ∈{0, 1, . . . , 2L−1} is given as i_{1,8,1i}=Σ₁₌^{i_1}\hat{ }*k_{1,i,0}⁽³⁾−1 and i_{1,8,1}=i₁* for v=1 and 1<v≤4, respectively.

Each reported LC coefficient (complex coefficient) in W^{~}₁ is separately quantized amplitude and phase.

### {Amplitude Quantization}

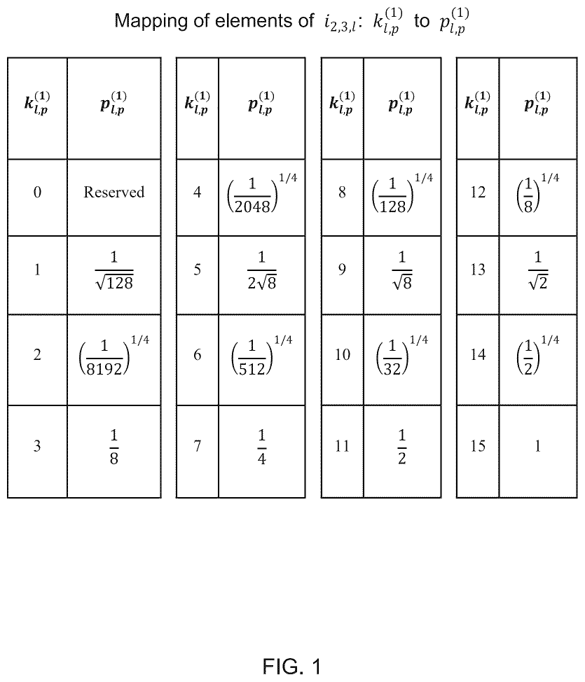

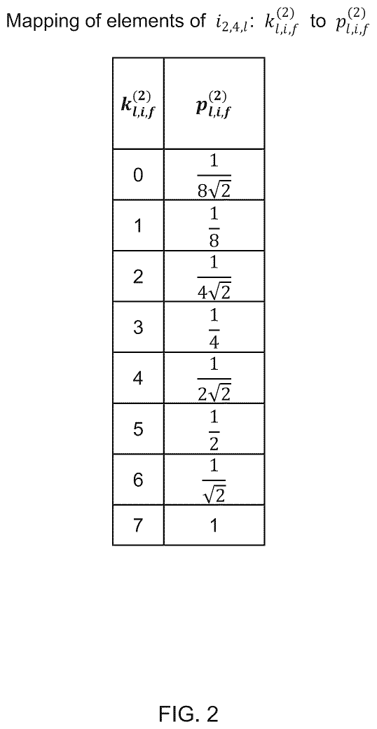

Polarization-specific reference amplitude is 16-level quantization using a table of FIG. 1 (mapping of elements in amplitude coefficient indicator i_{2,3,1}: mapping from amplitude coefficient indicator element k_{1,p}⁽¹⁾ to amplitude coefficient p_{1,p}⁽¹⁾). This table quantizes p₁⁽¹⁾=[p_{1,0}⁽¹⁾, p_{1,1}⁽¹⁾] to [k_{1,0}⁽¹⁾, k_{1,1}⁽¹⁾], k_{1,p}⁽¹⁾∈{0, . . . , 15}. All the other coefficients are 8-level quantization using a table of FIG. 2 (mapping of elements in amplitude coefficient indicator i_{2,4,1}: mapping from amplitude coefficient indicator element k_{l,i,f}⁽²⁾ to amplitude coefficient p_{1,i,f}⁽²⁾). This table quantizes p₁⁽²⁾=[p_{1,0}⁽²⁾, . . . , p_{1,Mv-1}⁽²⁾] and p_{1,f}⁽²⁾=[p_{1,0,f}⁽²⁾, . . . , p_{1,2L-1.f}⁽²⁾] to k_{l,f}⁽²⁾=[k_{l,0,f}⁽²⁾, . . . , k_{1,2L-1.f}⁽²⁾] and k_{1,i,f}⁽²⁾∈{0, . . . , 7}.

### {Phase Quantization}

Elements (amplitude coefficient indicator elements) [c_{1,0}, . . . , c_{l,M_v-1}] in amplitude coefficient indicator i_{2,5,1} are reported by the UE (by using 4 bits). All the phase coefficients are quantized by using 16-PSK. A phase coefficient with quantity for co-phasing φ_{l,i,f}=exp(j2πc_{l,i,f}/16) is quantized to c_{l,f}=[c_{1,0,f}, . . . , c_{l,2L-1.f}], c_{l,i,fi} ∈{0, . . . , 15}.

Amplitude coefficient indicator element k_{l,floor(i_l\hat{ }*/L)}⁽¹⁾, amplitude coefficient indicator element k_{1,i_1\hat{ }*,0}⁽²⁾, and phase coefficient indicator element c_{1,i_1\hat{ }*,0}⁽²⁾ corresponding to the strongest coefficient for layer l=15 (maximum value), 7 (maximum value), and 0 (minimum value), respectively. For l=1, . . . , v, k_{l,floor(i_l\hat{ }*/L)}⁽¹⁾, k_{l,i_l\hat{ }*,0}⁽²⁾, and c_{l,i_l\hat{ }*,0}⁽²⁾=0 are not reported.

i_{1,5} and i_{1,6,1} are PMI indices for FD DFT base reporting. i_{1,5} is reported only when N₃>19.

Matrix W^{(v)} indicated by a codebook for v (=1 to 4)-layer CSI reporting using 3000 to 2999+P_{CSI-RS} is based on matrix W¹ expressed by the following equation for layer l (=1 to v).

$$( G1 )$$

$${W}_{{q}_{1} , {q}_{2} , {n}_{1} , {n}_{2} , {n}_{3 , l} {p}_{l}^{( 1 )} , {p}_{l}^{( 2 )} {λ}_{2 , 5 , 1} λ}^{l} = \frac{1}{\sqrt{{N}_{1} {N}_{2} , {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{v} - 1} {y}_{t , l}^{( f )} {p}_{l , i , f}^{( 2 )} {φ}_{l , i , f} \\ {\sum }_{i = 0}^{L - 1} {v}_{{m}_{1}^{( i )} , {m}_{2}^{( i )}} {p}_{l , 1}^{( 1 )} {\sum }_{f = 0}^{{M}_{v} - 1} {y}_{t , l}^{( f )} {p}_{l , i + 1 , f}^{( 2 )} {φ}_{l , i + 1 , f}\end{matrix} ] , l = 1 , 2 , 3 , 4 ,$$

$${γ}_{t , l} = {\sum }_{i = 0}^{2 L - 1} {( {p}_{l , \vert \frac{i}{L} \vert}^{( 1 )} )}^{( 2 )} {\vert {\sum }_{f = 0}^{{M}_{v} - 1} {y}_{t , l}^{( f )} {p}_{l , i , f}^{( 2 )} {φ}_{l , i , f} \vert}^{2}$$

Here, beam index i=0, 1, . . . , L−1, m₁⁽ⁱ⁾=O₁n₁⁽ⁱ⁾+q₁, m₂⁽ⁱ⁾=O₂n₂⁽ⁱ⁾+q₂, n₁⁽ⁱ⁾∈{0, 1, . . . , N₁−1}, and n₂⁽ⁱ⁾∈{0, 1, . . . , N₂−1}. v_{m_1\hat{ }(i),m_2\hat{ }(i)}, p_{1,0}⁽¹⁾, p_{1,i,f}⁽²⁾, and φ_{l,i,f} indicate an SD 2D-DFT base, an amplitude coefficient, and a phase coefficient, respectively. Thus, a codebook for each layer includes the strongest coefficient per polarization, an amplitude coefficient per polarization, per FD-DFT base, and per SD-DFT base, and a phase coefficient per polarization, per FD-DFT base, and per SD-DFT base.

As grouping of CSI parts 2, for a given CSI report, PMI information is grouped into three groups (groups 0 to 2). This is important for a case where CSI omission is performed. Each reported element of indices i_{2,4,1}, i_{2,5,1}, and i_{1,7,1} is associated with a specific priority rule. Groups 0 to 2 follow the following.
Group 0: indices i_{1,1}, i_{1,2} and i_{1,8,1}(l=1, . . . , v)
Group 1: highest (higher) v2LMᵥ-floor(K^{NZ}/2) priority elements in index i_{1,5}(if reported) and indices i_{1,6,1} and i_{1,7,1} (if reported), highest (higher) ceil(K^{NZ}/2)-v priority elements in i_{2,3,1} and i_{2,4,1}, and highest (higher) ceil(K^{NZ}/2)-v priority elements in i_{2,5,1} (l=1, . . . , v)
Group 2: lowest (lower) floor(K^{NZ}/2) priority elements in i_{1,7,1}, lowest (lower) floor(K^{NZ}/2) priority elements in i_{2,4,1}, and lowest (lower) floor(K^{NZ}/2) priority elements in i_{2,5,1} (1=1, . . . , v)

In type 1 CSI, an SD beam indicated by an SD DFT vector is transmitted to the UE. In type 2 CSI, L SD beams are linearly coupled and transmitted to the UE. Each SD beam can be associated with a plurality of FD beams. For corresponding SD beams, channel frequency response can be obtained by using linear combination of FD base vectors for the SD beams. The channel frequency response corresponds to the power delay profile.

### (Type 2 Port Selection Codebook/Enhancement (Rel. 16)/Further Enhancement (Rel. 17))

In type 2 port selection (PS) CSI (type 2 PS codebook) of Rel. 15, a UE does not need to derive an SD beam in consideration of 2D-DFT, in a manner similar to that of the type 2 CSI. A base station transmits CSI-RSs by using K CSI-RS ports beamformed in consideration of a set of SD beams. The UE selects/identifies the best L (≤K) CSI-RS ports for each polarization, and reports indices of these ports in W₁. The type 2 PS CSI of Rel. 15 supports ranks 1 and 2.

Operation for type 2 PS CSI (enhanced type 2 PS codebook) of Rel. 16 is the same as that for the type 2 CSI of Rel. 16, except for SD beam selection. The type 2 PS CSI of Rel. 15 supports ranks 1 to 4.

For layer 1 ∈{1, 2, 3, 4}, per-subband (subband (SB)-wise) precoder generation is given by the following equation.

W₁(Nₜ×N₃)=QW₁W^{~}₁W_{f,1}^{H} (H1)

Here, Q(Nₜ×K) indicates K SD beams used for CSI-RS beamforming. W₁(K×2L) is a block diagonal matrix. W^{~}₁(2L×M) is an LC coefficient matrix. W_{f,1}(N₃×M) is formed by N₃ FD-DFT base vectors (FD base vectors). K is configured by a higher layer. L is configured by a higher layer. P_{CSI-RS} ∈{4, 8, 12, 16, 24, 32}. When P_{CSI-RS}>4, L∈{2, 3, 4}.

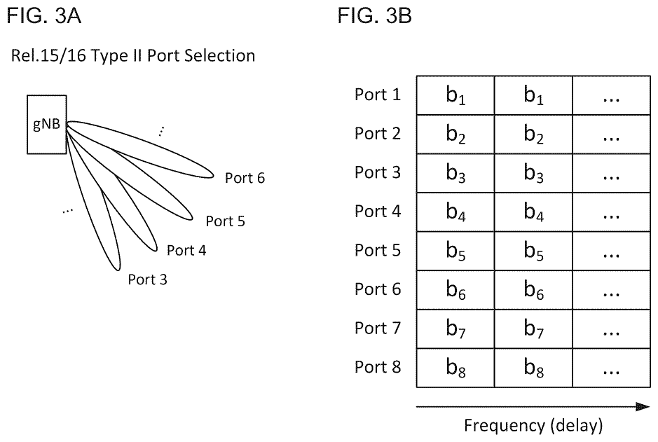

In type 2 PS CSI of Rel. 15/16, each CSI-RS port #i is associated with an SD beam (bᵢ) (FIGS. 3A and 3B).

The type 2 PS CSI of Rel. 16 reduces the number of FD base vectors from N₃ to Mᵥ (Mᵥ<<N₃) in a manner similar to that of type 2 CSI of Rel. 16, thereby reducing overhead as compared with that for the type 2 PS CSI of Rel. 15.

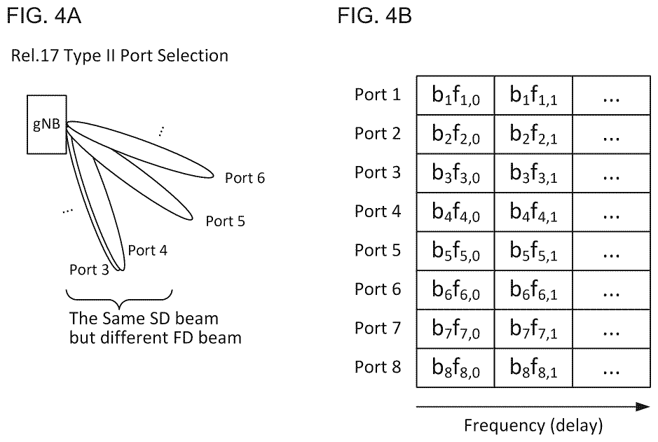

In type 2 port selection CSI/codebook of Rel. 17 (further enhanced type 2 port selection codebook), each CSI-RS port #i is associated with an SD-FD beam pair (pair of SD beam bᵢ and FD beam f_{i,j} (where j is a frequency index)) in place of an SD beam (FIGS. 4A and 4B). In this example, ports 3 and 4 are associated with the same SD beam and are associated with different FD beams.

Frequency selectivity of channel frequency response observed by the UE, based on an SD beam-FD beam pair can be reduced by delay pre-compensation more than frequency selectivity of channel frequency response observed by the UE, based on an SD beam.

A primary scenario for the type 2 port selection codebook of Rel. 17 is FDD. Channel reciprocity based on SRS measurement is imperfect (there is a possibility that an angle of a UL beam and an angle of a DL beam are different from each other, a UL frequency and a DL frequency are different from each other in FDD, effective antenna spacing differs between these UL and DL frequencies). Meanwhile, the base station can obtain/select some pieces of partial information (dominant angle and delay (SD beam and FD beam)). By using SRS measurement by the base station in addition to CSI reporting, the base station can obtain CSI for determination of a DL MIMO precoder. In this case, some CSI reports may be omitted to reduce CSI overhead.

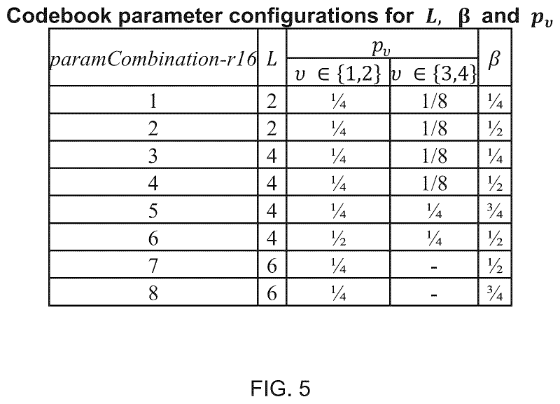

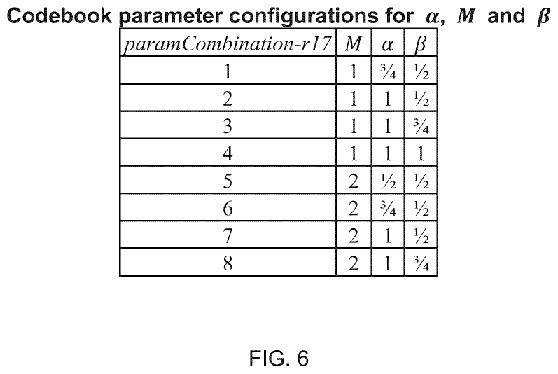

In the Rel-17 (further enhanced) type 2 port selection codebook, values of α, M, and β (parameter combination) are determined by a higher layer parameter “paramCombination-r17” (codebook parameter configuration). FIG. 5 shows an example of the parameter combination for the Rel-16 type 2 codebook. FIG. 6 shows an example of the parameter combination for the Rel-17 type 2 port selection codebook. A precoding matrix indicated by a PMI is determined based on L+M vectors. Here, L=K₁/2 and K₁=αP_{CSI-RS}.

In type 2 PS CSI of Rel. 17, each CSI-RS port is beamformed by using an SD beam and an FD base vector. Each port is associated with an SD-FD pair.

For given layer l, information based on the following equation may be reported by the UE.

$${W}_{1} ( K \times {N}_{3} ) = {W}_{1} {W}_{1}^{\sim} {W}_{f , {1}^{H}} \qquad ( H2 )$$

For W₁(K×2L), each matrix block is formed by L columns of a KxK identity matrix. The base station transmits K beamformed CSI-RS ports. Each port is associated with an SD-FD pair. The UE selects L ports from K ports, and reports, as part of PMI(W_{1,1}), the selected ports to the base station. Note that, in Rel. 16, each port is associated with an SD beam.

W^{~}₁(2L×Mᵥ) is a matrix formed by combination coefficients (subband complex LC coefficients). UP to K₀ NZCs are reported. The report is formed by two parts: a bitmap for identifying an NZC location, and a quantized NZC. In a specific case, the bitmap can be omitted. Note that, in Rel. 16, the bitmap for the NZC location is always reported.

W_{f,1} (N₃×Mᵥ) is a matrix formed by N₃ FD bases (FD-DFT bases). Mᵥ FD base vectors are present for each layer. The base station may delete W_{f,1}. When W_{f,1} is ON, M, additional FD base vectors are reported. When W_{f,1} is OFF, no additional FD base vectors are reported. Note that, in Rel. 16, W_{f,1} is always reported.

In the type 2 PS CSI of Rel. 17, K₁^{NZ}=Σᵢ₌₀^{k1-1}Σ_{f=0}^{M-1}k_{l,i,f}⁽³⁾≤K₀ is the number of non-zero coefficients in layer l=1, . . . , v, and K^{NZ}=Σₗ₌₁^{v}K₁^{NZ}≤2K₀ is a total number of non-zero coefficients. If v≤2 and K^{NZ}=K₁Mv, i_{1,7,l}(bitmap indicator for the l-th layer) for l=1, . . . , v is not reported. In other words, when a total number of reported NZCs is equal to a maximum number of K₁Mv and v≤2, reporting of a bitmap indicating a location of the NZCs is omitted.

### (Configuration of CSI-RS Resource and CSI Report)

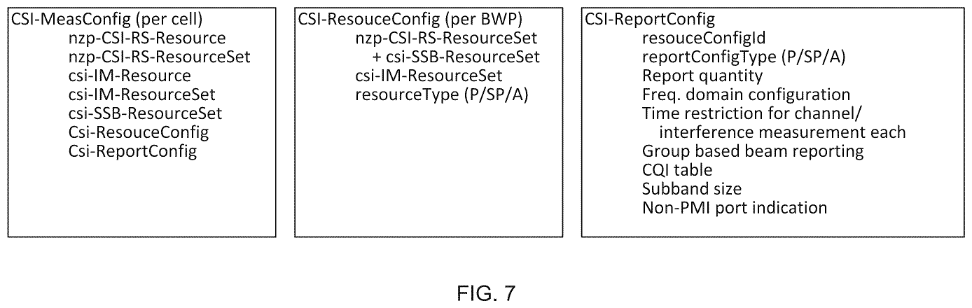

As shown in the example of FIG. 7, a relationship between the CSI-RS resources and the CSI report is configured by a CSI measurement configuration (CSI-MeasConfig) configured for each cell, a CSI resource configuration (CSI-ResourceConfig) configured for each BWP, and a CSI report configuration (CSI-ReportConfig).

CSI-MeasConfig includes at least one of a non-zero power (NZP) CSI-RS resource configuration “nzp-CSI-RS-Resource,” an NZP-CSI-RS resource set configuration “nzp-CSI-RS-ResourceSet,” a CSI-interference measurement (IM) resource configuration “csi-IM-Resource,” a CSI-IM resource set configuration “csi-IM-ResourceSet,” a CSI-SSB resource set configuration “csi-SSB-ResourceSet,” a CSI resource configuration “CSI-ResourceConfig,” and a CSI report configuration “CSI-ReportConfig.”

CSI-ResourceConfig includes at least one of nzp-CSI-RS-ResourceSet, csi-SSB-ResourceSet, csi-IM-ResourceSet, and a resource type “resourceType (periodic (P)/semi-persistent (SP)/aperiodic (A)).”

CSI-ReportConfig includes at least one of a resource configuration ID “resourceConfigId,” a report configuration type “reportConfigType (P/SP/A),” a report quantity, a frequency domain configuration, a time restriction on each of channel measurement/interference measurement, a group-based beam report, a CQI table, a subband size, and a non-PMI port indication.

### (Doppler CSI)

It is studied that time-domain correlation/Doppler-domain (DD) information is used to enhance/improve a capability for a CSI report for a UE that moves at high/middle speed. For example, studies have been carried out on improvement of the type 2 codebook of Rel. 16/17 and reporting of time domain channel characteristics (time domain channel properties, TDCP) measured via a tracking CSI-RS (tracking RS (TRS)) from the UE without changing spatial domain bases and frequency domain bases.

A channel coherent time (CCT) depends on a maximum Doppler shift. The channel coherent time is a time when measured channel properties are available or a time until measured channel properties become unavailable (channel aging). The maximum Doppler shift is estimated by a relative speed between a transmitter and a receiver. The channel coherent time T_{c} is approximated by 1/Δfₘₐₓ. Here, Δfₘₐₓ=v/λ. As the moving speed of the UE is higher, the channel coherent time is shorter. For example, the channel coherent time falls below 10 ms when the moving speed exceeds approximately 25 km/h at a carrier frequency of 4.5 GHz. How to handle such high moving speed and short channel coherent time is an issue.

A TRS is supported to track a Doppler shift. Meanwhile, the TRS has the following issues.
The number of ports per CSI-RS resource set is limited to only one. Each CSI-RS resource uses a single port.
A configurable periodicity is 10 ms or greater.
A CSI report for the TRS is not assumed. There is no report configuration for a P-TRS. The report can be configured, but a report quantity (reportQuantity) is set to only ‘none.’ Up to 16 CSI-RS resources are used per CSI-RS resource set.

The TRSs are arranged in resources of the time domain and the frequency domain. Measurement of influence by a Doppler shift requires, in a specific frequency domain resource, a plurality of RSs in the time domain.

It is conceivable that a CMR is used for the measurement of influence by a Doppler shift. Meanwhile, an RS to be used for the measurement depends on UE implementation.

Information related to the Doppler shift is not supported for a quantity of the CSI report. Information for determination of W=W₁W₂ is reported by the UE via a CSI codebook (PMI). Here, W₁ is wideband property, and indicates a spatial beam. W₂ is subband property, and indicates a coefficient of amplitude/phase for each spatial beam.

For the measurement related to the Doppler shift, the following cases are conceivable: case 1 where the UE performs measurement, based on a CSI-RS; and case 2 where the base station performs measurement, based on an SRS. For judgment of the influence by the Doppler shift, the following cases are conceivable: case 1-1 where the UE performs judgment, based on a CSI-RS measurement result; case 1-2 where the base station performs judgment, based on a CSI-RS measurement result reported by the UE; and case 2-1 where the base station performs judgment, based on an SRS measurement result.

A CSI-RS measurement window and a CSI reporting window are under study. In the CSI-RS measurement window, one or more CSI-RS occasions may be measured. CSI to be reported may be associated with the CSI reporting window.

On the assumption of the CSI report in a slot n, the length of the Doppler domain (DD)/time domain (TD) base vector (DFT base vector) (the number of DD/TD bases) may be represented by N₄. In the CSI measurement window of slot[k, k+Wₘₑₐₛ−1], one or more CSI occasions for calculation of the CSI report may be measured. Here, k may be a slot index, and Wₘₑₐₛ may be a measurement window length (the number of slots). The CSI occasion may be configured in CSI-ReportConfig. The CSI reporting window of slot[l, l+W_{CSI}−1] may be associated with the CSI report in the slot n. Here, l may be a slot index, and W_{CSI} may be a reporting window length (the number of slots). The position of a CSI reference resource may be represented by n_{ref}.

Duration W_{CSI} of the CSI reporting window=dN₄. d and N₄ are determined by a CMR configuration. A starting point of the CSI reporting window is slot l. l may equal (n−N_{CSI,ref}). l may equal (n+δ). δ may equal {0, 2}, or may equal {0, 1, 2, 3, 4, 5}.

d slots may be duration in DD units.

When UE-side prediction is assumed, the UE is supported to predict CSI/channel after slot l, and the base station configures a location of slot l (from a plurality of candidate values) via higher layer signaling. The plurality of candidates for the location of slot 1 include existing CSI reference resource locations (n−N_{CSI,ref}) and (n+δ). Here, δ>0. Existing CSI reference resources in existing operation, that is (n−N_{CSI,ref}), are reused to indicate a location of the last CSI-RS occasion used for CSI reporting.

An additional value of 2 is supported for parameter δ.

N₄ is configured by the base station via higher layer signaling.

When N₄=1, DD bases may be the same (identity). DD compression may be absent. A codebook structure in this case may be, for example, the following equation.

$$W = {W}_{1} {{\tilde{W}}_{2} ( {W}_{f} )}^{H} \qquad ( I1 )$$

When N₄>1, a Doppler domain orthogonal DFT base may be selected in common for all the SD/FD bases. A codebook structure in this case may be, for example, the following equation.

$$W = {W}_{1} {{\tilde{W}}_{2} ( {W}_{f} ⊗ {W}_{d} )}^{H} \qquad ( I2 )$$

Only Q>1 indicating the number of selected Doppler domain (DD) base vectors is allowed. Detailed design of the SD/FD bases including associated UCI parameters follows an existing specification.

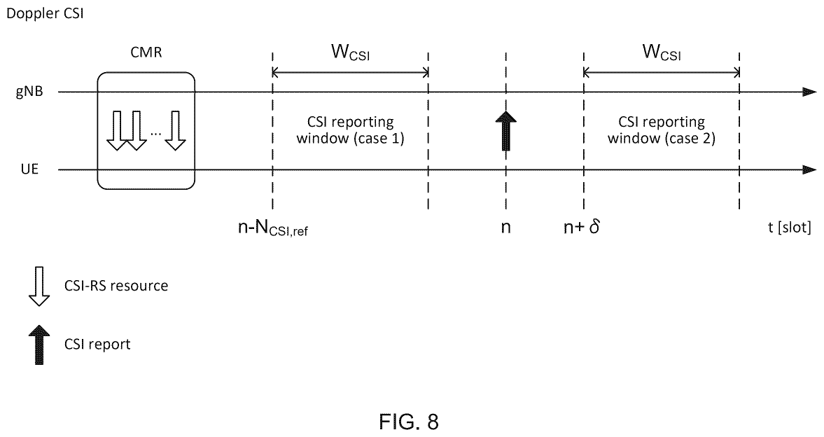

FIG. 8 shows an example of a timing of measurement/reporting of Doppler CSI. CSI reporting (based on CMR measurement and CSI prediction) in slot n includes CSI information in a CSI reporting window. A CSI reporting window of case 1 after a plurality of CMRs spans W_{CSI} slots from slot (n−N_{CSI,ref}). Slot (n−N_{CSI,ref}) may be referred to as a CSI reference slot. The CSI reporting is performed in slot n after the CSI reporting window of case 1. A CSI reporting window of case 2 after the CSI reporting spans W_{CSI} slots from slot (n+δ).

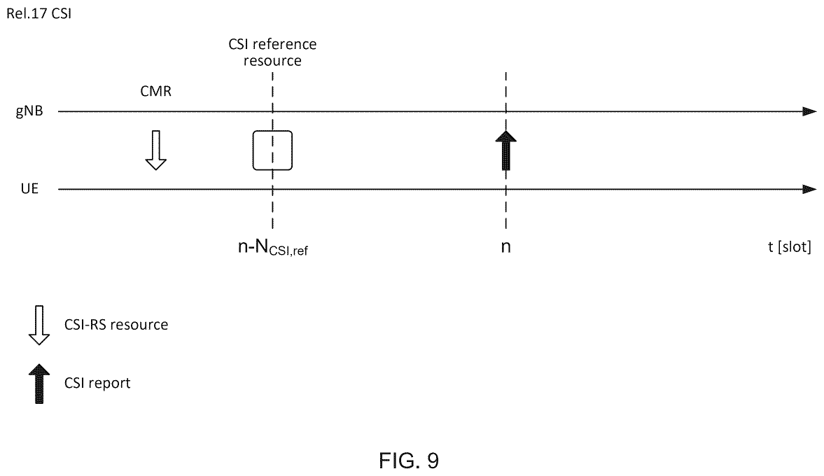

FIG. 9 shows an example of a timing of measurement/reporting of Rel-17 type 2 CSI. CSI is calculated in a CSI reference slot (n−N_{CSI,ref}) after a CMR, and CSI reporting is performed in slot n after the CSI reference slot.

It is studied that the following CSI-RS resource types/structures are supported for CMRs for Doppler CSI.
Time domain behavior (behaviour) for NZP CSI-RS resources: periodic (P), semi-persistent (SP), aperiodic (AP)
K>1 NZP CSI-RS resources for AP-CSI-RS based channel measurement in the same CSI-RS resource set The K NZP CSI-RS resources may be received via a single triggering instance. Only one NZP CSI-RS resource for P-CSI-RS based channel measurement or SP-CSI-RS based channel measurement may be supported. A separation between two consecutive AP-CSI-RS resources may be m slots.

Regarding parameter d in a plurality of slots, if a configured CMR is an AP-CSI-RS, a candidate value for d may be a configured value of m parameter. When more than one candidate value for d is supported, a value of d is configured by the base station via higher layer (RRC) signaling.

Some policies below are conceivable for a relationship between a P/SP-CMR configuration and a CSI reporting window (parameter d).

### Policy 1

d is supported to be a periodicity. To achieve favorable CSI prediction performance, d needs to be small. A P/SP-CMR at a short periodicity causes insufficient resource utilization.

### Policy 2

For CMRs per CMR set, d independent of a periodicity is supported. For example, d<periodicity. N₄ PMIs (each PMI corresponding to d) are calculated by a smaller number of CMRs.

### Policy 3

A plurality of CMRs with time domain separation in a P/SP NZP CSI-RS resource set are supported. The time domain separation may be d.

### Policy 4

A plurality of CMRs with time domain separation over a plurality of P/SP NZP CSI-RS resource sets are supported. The time domain separation may be d.

### (CSI Reference Resource)

A CSI reference resource for a serving cell is defined as follows.
In the frequency domain, the CSI reference resource is defined by a group of a plurality of DL PRBs corresponding to a band with which derived CSI is associated.
In the time domain, the CSI reference resource is defined by a single DL slot n-n_{CSI-ref}−K_{offset}·2^{μ_DL}/2^{μ_Koffset}. Here, K_{offset} is a parameter configured by a higher layer, and μ_K_{offset} is a subcarrier spacing configuration for K_{offset}, and has a value of 0 in FR1. μ_DL is a subcarrier spacing configuration for DL.
In a P/SP-CSI report, if a single CSI-RS/SSB for channel measurement is configured, n_{CSI_ref} is a minimum value greater than or equal to 4·2^{μ_DL} and configured such that n_{CSI_ref} corresponds to a valid DL slot. If a plurality of CSI-RSs/SSBs for channel measurement are configured, n_{CSI_ref} is a minimum value greater than or equal to 5·2^{μ_DL} and configured such that n_{CSI_ref} corresponds to a valid DL slot.
In an AP-CSI report, if the UE is indicated with reporting of CSI in the same slot as that for a CSI request, by DCI, n_{CSI_ref} includes a reference resource in the same valid DL slot as that for the corresponding CSI request, otherwise n_{CSI_ref} is a minimum value greater than or equal to floor(Z′/N_{symb}^{slot}) and configured such that slot n_{CSI_ref} corresponds to a valid DL slot. Here, Z′ corresponds to a latency requirement. N_{symb}^{slot} is the number of symbols in the slot.
When a P or SP CSI-RS/CSI-IM or SSB is used for channel/interference measurement, the UE is not expected to measure a channel/interference related to a CSI-RS/CSI-IM/SSB for which a last OFDM symbol is received by the time Z′ symbols before a transmission time of a first OFDM symbol for an AP-CSI report.

When a slot in the serving cell includes at least a DL or flexible symbol configured by a higher layer, and is not within a measurement gap configured for the UE, the slot is regarded as a valid DL slot.

### (Analysis)

Some issues below are conceivable in type 2 Doppler CSI.
(Issue 1) It is unclear how P/SP-CMRs for the type 2 Doppler CSI are configured to achieve an appropriate amount of CMRs for CSI prediction, and smaller resource overhead.
(Issue 2) It is unclear how a set of a plurality of CMRs used for a single instance of a type 2 Doppler CSI report is determined.

Unless such issues are clear, throughput reduction/communication quality degradation or the like may be caused.

In view of this, the inventors of the present invention came up with the idea of a method for configuration/reporting for Doppler CSI.

Embodiments according to the present disclosure will be described in detail with reference to the drawings as follows. Note that respective embodiments (for example, respective cases) below may each be employed individually, or at least two of the respective embodiments may be employed in combination.

In the present disclosure, “A/B” and “at least one of A and B” may be interchangeably interpreted. In the present disclosure, “A/B/C” may mean “at least one of A, B, and C.”

In the present disclosure, notify, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, another message (message from a core network, such as a positioning protocol (for example, NR Positioning Protocol A (NRPPa)/LTE Positioning Protocol (LPP)) message), and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, a_{b}^{c} and a_b\hat{ }c may be interchangeably interpreted. In the present disclosure, a_{b} and a_b may be interchangeably interpreted. In the present disclosure, a_{c} and a\hat{ }c may be interchangeably interpreted. In the present disclosure, ceil(x) and a ceiling function may be interchangeably interpreted. In the present disclosure, floor(x) and a floor function may be interchangeably interpreted.

In the present disclosure, a base, a DFT base, a base vector, and a DFT base vector may be interchangeably interpreted. In the present disclosure, an SD base, an SD-DFT base, a beam, an SD beam, an SD 2D-DFT vector, an SD base vector, a beam index, and i may be interchangeably interpreted. In the present disclosure, L, the number of SD beams, the number of beams, and the number of SD 2D-DFT vectors may be interchangeably interpreted. In the present disclosure, an FD base, an FD-DFT base, an FD beam, an FD base vector, an FD-DFT base vector, an FD base vector index, and f may be interchangeably interpreted. In the present disclosure, a DD base, a DD-DFT base, a DD base vector, and a DD-DFT base vector may be interchangeably interpreted.

In the present disclosure, a size, a length, and a number may be interchangeably interpreted.

### (Radio Communication Method)

In each of the respective embodiments, type 2 Doppler CSI and Doppler CSI based on at least one of enhanced type 2 CSI (Rel. 16) and further enhanced type 2 PS CSI (Rel. 17) may be interchangeably interpreted.

In each of the respective embodiments, an NZP CSI-RS resource set, a CSI-RS resource set, a CSI resource configuration, and a channel measurement NZP CSI-RS resource set may be interchangeably interpreted. In each of the respective embodiments, a CMR, an NZP CSI-RS resource, a CSI-RS resource, and a CSI-RS occasion may be interchangeably interpreted.

When more than one CMR is configured in one P/SP CSI-RS resource set, operation in Embodiment #3 may be applied to Embodiment #2.

### Embodiment #1

This embodiment relates to Issue 1, and relates to CMR configuration for Doppler CSI.

### Embodiment #1-1

One P/SP-CSI-RS resource set for the Doppler CSI may follow at least one of some alternatives below.

### Alternative 1

In the P/SP-CSI-RS resource set, one NZP CSI-RS resource (CMR) is configured.

### Alternative 2

In the P/SP-CSI-RS resource set, more than one NZP CSI-RS resource (CMR) is configured.

### Embodiment #1-1a

When one CMR is configured in one P/SP-CSI-RS resource set, CMR configuration may follow an option below.

### Option 1

The CMR configuration relates to time domain behavior. For example, a periodicity is a maximum periodicity “MAX_P” or less. MAX_P may be defined in a specification, or may be configured/indicated via an RRC IE/MAC CE/DCI.

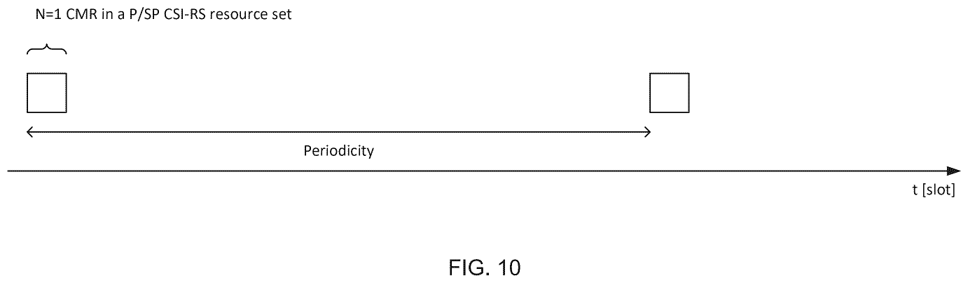

FIG. 10 shows an example of the CMR configuration according to Embodiment #1-1a. In this example, N=1 CMR with the periodicity is configured in one P/SP-CSI-RS resource set.

### Embodiment #1-2

When more than one CMR is configured in one P/SP-CSI-RS resource set, CMR configuration may follow at least one of some alternatives below.

### Alternative 1

The CMR configuration includes configurations of a time domain offset, the number of CMRs, and a specific resource for each CMR. The time domain offset may be an offset between two consecutive CMRs, or may be an offset between the first/earliest/configured CMR and another CMR.

### Alternative 2

The CMR configuration includes a configuration of a specific resource for each of N CMRs.

### Embodiment #1-3

When more than one CMR is configured in one P/SP-CSI-RS resource set, the plurality of CMRs may follow at least one of some alternatives (rules/restrictions) below.

### Alternative 1

The plurality of CMRs follow a rule related to a separation between two consecutive CMRs. For example, a separation between two consecutive CMRs is the same. For example, the separation between two consecutive CMRs is a factor for determination of CSI reporting window configuration.

### Alternative 2

The plurality of CMRs follow a rule related to the number of ports in each CMR. For example, the number of ports is the same for any CMR.

### Alternative 3

The plurality of CMRs follow a rule related to a frequency domain resource for each CMR. For example, a frequency domain resource is the same for any CMR.

### Alternative 4

The plurality of CMRs follow a rule related to a time domain resource in one slot for each CMR. For example, a time domain resource is the same for any CMR.

### Alternative 5

The plurality of CMRs follow a rule related to a time domain resource (for example, a periodicity/offset) for each CMR. For example, a periodicity is the same for any CMR. For example, the periodicity is a maximum periodicity “MAX_P” or less. MAX_P may be defined in a specification, or may be configured/indicated via an RRC IE/MAC CE/DCI. MAX_P may be 4 or another value. For example, an offset differs for each CMR.

### Alternative 6

The plurality of CMRs follow a rule related to transmission power for each CMR. For example, transmission power (for example, energy per resource element (EPRE)) is the same for any CMR. For example, EPRE between any CMR and an SS/PBCH block is the same.

In a case of Alternative 1 of Embodiment #2 described below, the above-described restrictions may mean that RRC configuration for each CMR is restricted.

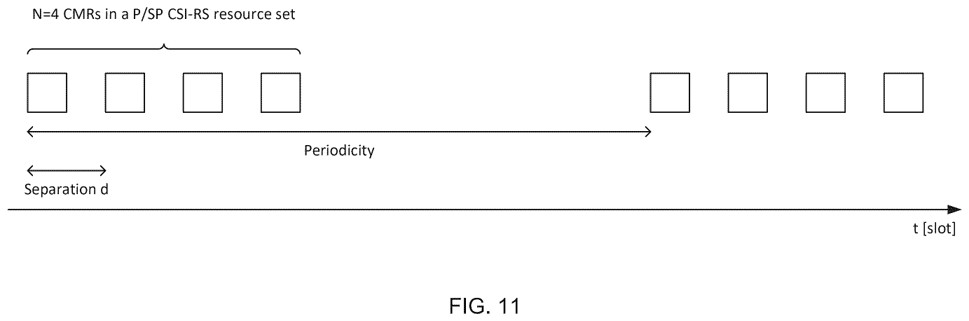

FIG. 11 shows an example of the CMR configuration according to Embodiment #1-3. In this example, N=4 CMRs are configured in one P/SP-CSI-RS resource set. A separation between two consecutive CMRs may be equal to d.

This embodiment allows a UE to be appropriately configured with a plurality of CMRs for Doppler CSI reporting.

### Embodiment #2

This embodiment relates to Issue 2, and relates to identification of a plurality of CMRs for CSI reporting in a case where only one NZP CSI-RS resource set is assumed.

According to a specification of Rel. 17 (or earlier versions), when a CMR is P/SP, an exact CMR for CSI reporting in slot n (an exact periodicity including a CMR used for CSI measurement) follows some definitions below.
If timeRestrictionForChannelMeasurement is set to “Configured,” the exact CMR is only the latest occasion of an NZP CSI-RS before a CSI reference resource.
If timeRestrictionForChannelMeasurement is set to “notConfigured,” the exact CMR is only an occasion of an NZP CSI-RS before the CSI reference resource.

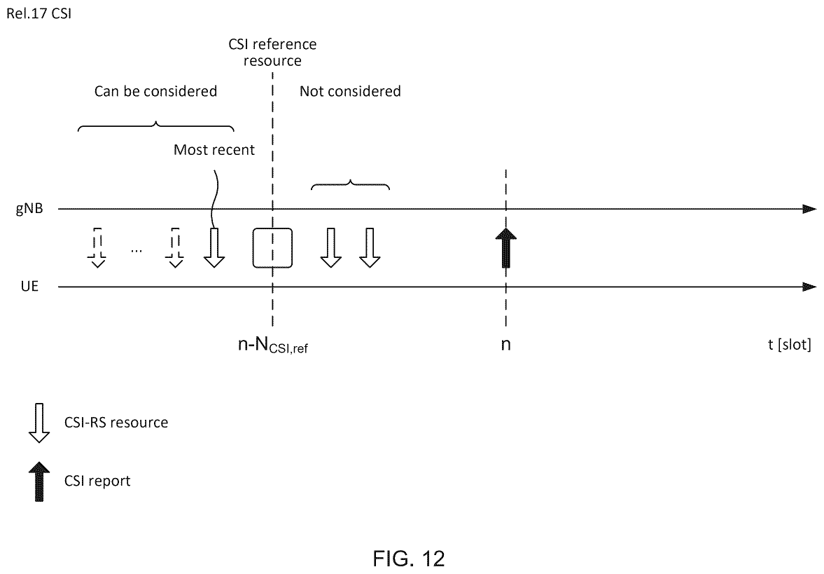

FIG. 12 shows an example of the CMR in Rel. 17 (or earlier versions). CMRs in CSI-RS occasions before a CSI reference resource in slot (n−N_{CSI.ref}) can be considered, and CMRs in CSI-RS occasions after the CSI reference resource are not considered.

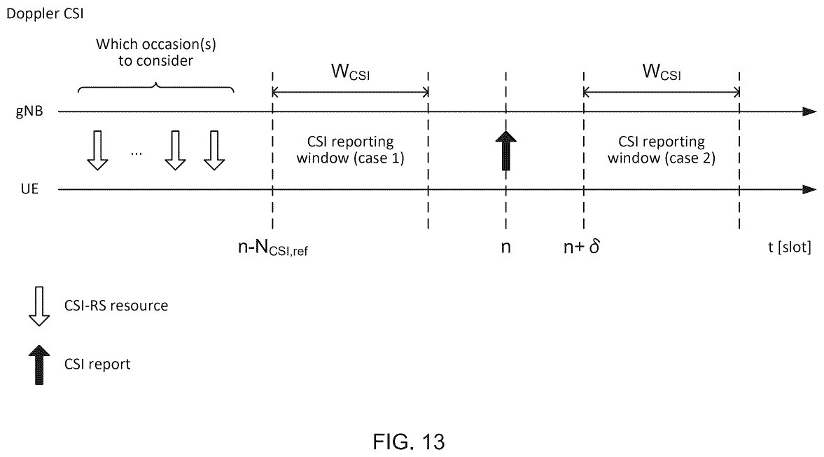

In type 2 Doppler CSI, if a P/SP-CMR is configured, it is unclear which CMR is considered (FIG. 13). A plurality of CMRs for one CSI report are to be considered. In an AP-NZP CSI-RS resource set, a plurality of CMRs are considered, and are triggered in DCI. In a P/SP-NZP CSI-RS resource set, only one CMR is configured. CSI prediction performance is considered to depend on CMR selection.

### Embodiment #2-1

In the type 2 Doppler CSI, when one P/SP-CSI-RS resource set with only one CMR is configured, the number N′ of NZP CSI-RS occasions for one CSI report may be based on at least one of some approaches below.

### Approach 1

N′ is explicitly configured/indicated by a NW. The configuration/indication may be performed by an RRC IE/MAC CE/DCI. N′ may be used to determine CSI reporting window configuration. For example, N′ is duration of a CSI reporting window (for example, the number of slots).

### Approach 2

N′ is implicitly derived by another configuration. For example, N′ is derived by duration of a CSI reporting window. For example, N′ is derived by a length of a Doppler domain DFT vector. For example, N′ is equal to the number of Doppler domain DFT bases (vector length, for example, N₄).

### Embodiment #2-2

In the type 2 Doppler CSI, when one P/SP-CSI-RS resource set with only one CMR is configured, N′ NZP CSI-RS occasions may be determined in consideration of at least one of some options below.

### Option 1

A relationship with a CSI reference resource is considered. For example, all of the N′ NZP CSI-RS occasions are before the CSI reference resource.

### Option 2

A timing of a last NZP CSI-RS occasion among the N′ NZP CSI-RS occasions is considered. For example, the last NZP CSI-RS occasion is the latest NZP CSI-RS occasion before the CSI reference resource.

### Option 3

Whether the N′ NZP CSI-RS occasions are consecutive is considered. For example, there is an equal separation between any two consecutive NZP CSI-RS occasions. In other words, in the N′ NZP CSI-RS occasions, a periodicity may not be skipped.

Which one or more of the above-described some options are considered in determination of the N′ NZP CSI-RS occasions, or whether, for the N′ NZP CSI-RS occasions, one or more of the above-described some options are considered in determination of the N′ NZP CSI-RS occasions may be based on at least one of RRC configuration and UE capability signaling.

One or more options not to be considered in determination of the N′ NZP CSI-RS occasions, from among the above-described some options, may depend on UE implementation.

### Embodiment #2-3

In the type 2 Doppler CSI, when one P/SP-CSI-RS resource set with only one CMR is configured, determination of N′ NZP CSI-RS occasions may be operated by at least one of some alternatives below.

### Alternative 1

The determination of N′ NZP CSI-RS occasions follows configuration by a base station. The NW/base station can determine the N′ NZP CSI-RS occasions so that CSI to be reported by the UE is appropriate for administration.

### Alternative 2

The determination of N′ NZP CSI-RS occasions follows determination by the UE. The determination of N′ NZP CSI-RS occasions may follow at least one of some alternatives below.

### Alternative 2-1

The determination of N′ NZP CSI-RS occasions depends on UE implementation (is not defined in a specification). This enables flexible UE implementation, thereby leading to a wider spread of a UE with this capability.

### Alternative 2-2

The UE determines N′ NZP CSI-RS occasions used for CSI measurement in one CSI report, and reports the determined occasions to the base station/NW. The NW/base station can recognize the selected N′ NZP CSI-RS occasions and exact quality of CSI obtained based on the selected occasions.

### Alternative 3

The determination of N′ NZP CSI-RS occasions follows configuration by the base station and determination by the UE. The NW/base station can narrow down occasions with the possibility of being selected to maintain quality of CSI to be reported, and the UE can have a degree of freedom related to implementation.

This embodiment allows a UE to appropriately identify a plurality of CMRs for Doppler CSI reporting in a case where only one NZP CSI-RS resource set is assumed.

### Embodiment #3

This embodiment relates to Issue 2, and relates to identification of a plurality of CMRs for CSI reporting in a case where a plurality of NZP CSI-RS resource sets are assumed.

### Embodiment #3-1

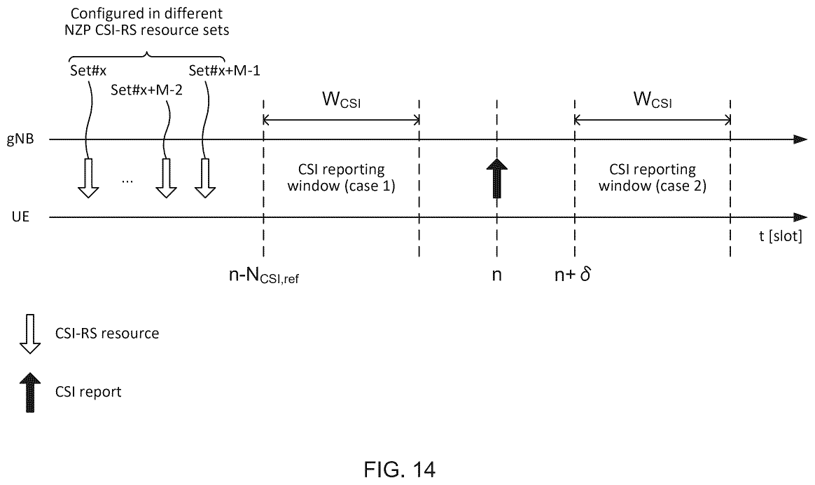

In type 2 Doppler CSI, when a P/SP-NZP CSI-RS resource set with only one CMR is configured, it may be considered that a plurality of respective CMRs for CSI measurement are configured together with a plurality of different NZP CSI-RS resource sets. FIG. 14 shows an example of configuration of the plurality of NZP CSI-RS resource sets. In this example, a plurality of NZP CSI-RS resource sets for channel measurement are configured, and each NZP CSI-RS resource set includes one CSI-RS resource.

### Embodiment #3-1-0

A relationship between configuration of one or more NZP CSI-RS resource sets and CSI reporting may follow at least one of some options below.

### Option 1

A plurality of P/SP CSI-RS resource sets associated with one CSI report configuration (CSI-ReportConfig) are configured.

### Option 2

A plurality of P/SP CSI-RS resource sets associated over a plurality of CSI report configurations (CSI-ReportConfig) are configured.

### Embodiment #3-1-1

A restriction related to configuration for a plurality of CMRs over a plurality of NZP CSI-RS resource sets may follow at least one of some options (rules/restrictions) below.

### Option 1

The plurality of CMRs follow a restriction related to a separation between two consecutive CMRs. For example, a separation between any two consecutive CMRs is the same. For example, the separation between two consecutive CMRs is a factor for determination of CSI reporting window configuration.

### Option 2

The plurality of CMRs follow a restriction related to the number of ports in each CMR. For example, the number of ports is the same for any CMR.

### Option 3

The plurality of CMRs follow a rule related to a frequency domain resource for each CMR. For example, a frequency domain resource is the same for any CMR.

### Option 4

The plurality of CMRs follow a rule related to a time domain resource in one slot for each CMR. For example, a time domain resource is the same for any CMR.

### Option 5

The plurality of CMRs follow a rule related to a time domain resource (for example, a periodicity/offset) for each CMR. For example, a periodicity is the same for any CMR. For example, the periodicity is a maximum periodicity “MAX_P” or less. MAX_P may be defined in a specification, or may be configured/indicated via an RRC IE/MAC CE/DCI. MAX_P may be 4 or another value. For example, an offset differs for each CMR.

### Option 6

The plurality of CMRs follow a rule related to transmission power for each CMR. For example, transmission power (for example, energy per resource element (EPRE)) is the same for any CMR. For example, EPRE between any CMR and an SS/PBCH block is the same.

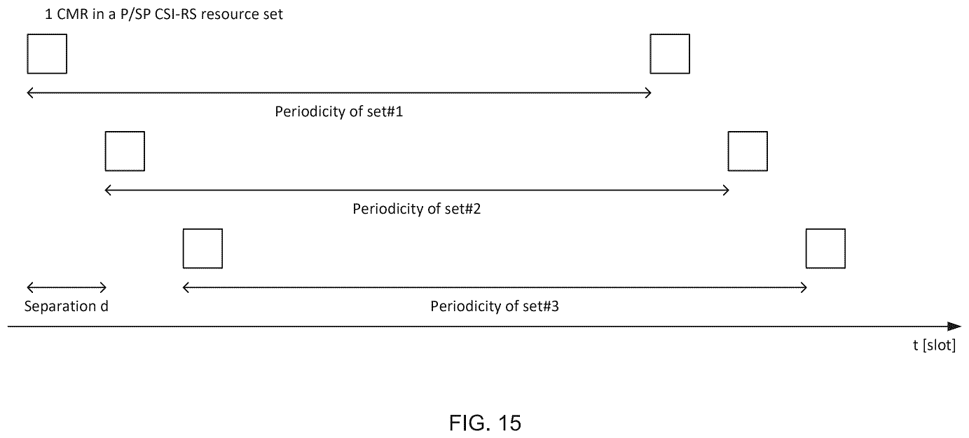

FIG. 15 shows an example of the CMR configuration according to Embodiment #3-1. In this example, one CMR is configured in each of a plurality of P/SP-CSI-RS resource sets. A separation between two consecutive CMRs may be equal to d. For the plurality of CSI-RS resource sets (CMRs), the same or different periodicities may be configured.

### Embodiment #3-1-2

The number N′ of NZP CSI-RS occasions for one CSI report may be based on at least one of some approaches below.

### Approach 1

N′ is explicitly configured/indicated by a NW. The configuration/indication may be performed by an RRC IE/MAC CE/DCI. The configuration/indication may be associated with one NZP CSI-RS resource set among the plurality of associated NZP CSI-RS resource sets. For example, the configuration may be present only in only one NZP CSI-RS resource set, and a CMR in the NZP CSI-RS resource set may be a last CMR among N′ consecutive CMRs. N′ may determine CSI reporting window configuration. For example, N′ is duration of a CSI reporting window.

### Approach 2

N′ is implicitly derived by another configuration. For example, N′ is derived by duration of a CSI reporting window. For example, N′ is derived by a length of a Doppler domain DFT vector. For example, N′ is equal to the number of Doppler domain DFT bases (vector length, for example, N₄).

### Embodiment #3-1-3

N′ NZP CSI-RS occasions may be determined in consideration of at least one of some options below.

### Option 1

A relationship with a CSI reference resource is considered. For example, all of the N′ NZP CSI-RS occasions are before the CSI reference resource.

### Option 2

A timing of a last NZP CSI-RS occasion among the N′ NZP CSI-RS occasions is considered. For example, the last NZP CSI-RS occasion is the latest NZP CSI-RS occasion before the CSI reference resource.

### Option 3

Whether the N′ NZP CSI-RS occasions are consecutive is considered. For example, there is an equal separation between any two consecutive NZP CSI-RS occasions. In other words, in the N′ NZP CSI-RS occasions, a periodicity may not be skipped.

### Option 4

CSI report configuration is considered. For example, M NZP CSI-RS resource sets are configured for one CSI report configuration. N′ CSI-RS occasions among M CSI-RS occasions may be determined. The determination of the N′ NZP CSI-RS occasions may be performed by a UE, based on at least one of Options 1 to 3, may be configured by an RRC IE (for example, an associated CSI report), or may be indicated via a MAC CE/DCI.

Which one or more of the above-described some options are considered in determination of the N′ NZP CSI-RS occasions, or whether, for the N′ NZP CSI-RS occasions, one or more of the above-described some options are considered in determination of the N′ NZP CSI-RS occasions may be based on at least one of RRC configuration and UE capability signaling.

One or more options not to be considered in determination of the N′ NZP CSI-RS occasions, from among the above-described some options, may depend on UE implementation.

### Embodiment #3-1-4

The rule for determination of the N′ NZP CSI-RS occasions in Embodiment #3-1-3 described above may be applied to one or more specific NZP CSI-RS resource sets. This application allows a common view of a CMR to be obtained by a base station and a UE, and thus an appropriate CMR can be selected. The specific NZP CSI-RS resource sets may follow at least one of some options below.

### Option 1

The one or more specific NZP CSI-RS resource sets are one explicitly configured NZP CSI-RS resource set. The explicit configuration may be configuration of N′ (the number of CMRs for one CSI report).

### Option 1a

The one or more specific NZP CSI-RS resource sets are a plurality of explicitly configured NZP CSI-RS resource sets.

### Option 2

The one or more specific NZP CSI-RS resource sets are implicitly configured based on a rule. For example, it is considered that N′ CMRs are a group of a plurality of CMRs with a separation of a single value (for example, d) between a set of a plurality of consecutive CMRs, and a last CMR (in other words, the CMR does not have a later CMR with a separation of d) is implicitly determined to be one CMR associated with one or more specific NZP CSI-RS resource sets.

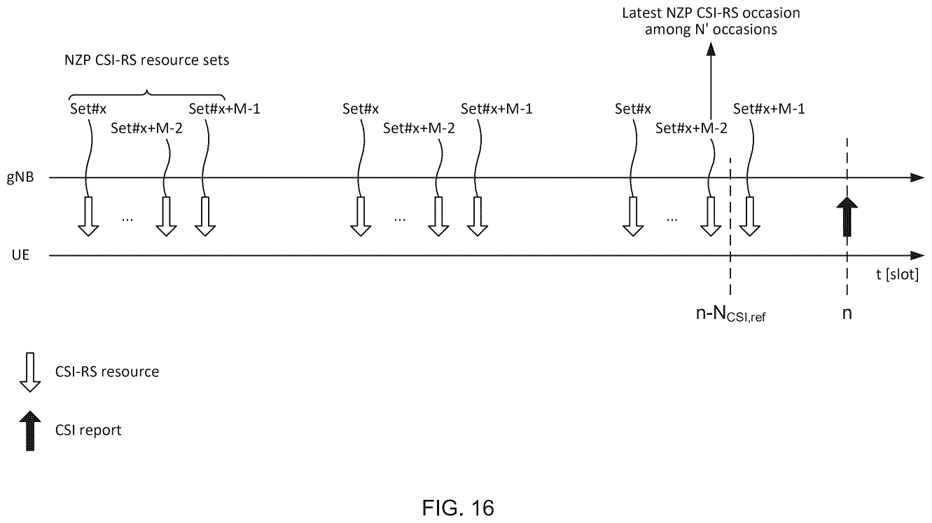

FIG. 16 shows an example of the plurality of NZP CSI-RS occasions according to Embodiment #3-1-3/#3-1-4. In this example, M P/SP-NZP CSI-RS resource sets #x to #x+M−1 are configured. Each NZP CSI-RS resource set includes one CMR. When the rule of Embodiment #3-1-3 is applied to all the NZP CSI-RS resource sets, M CMRs may be determined such that a last CMR of the M CMRs is a last CMR (NZP CSI-RS resource set #x+M−2) before a CSI reference resource (slot (n−N_{CSI,ref})). Based on Embodiment #3-1-4, when the rule of Embodiment #3-1-3 is applied to only specific NZP CSI-RS resource set #x+M−1, M CMRs may be determined such that a last CMR of the M CMRs is a last CMR (NZP CSI-RS resource set #x+M−1) of a set of a plurality of consecutive CMRs with a certain separation.

### Variation

In the type 2 Doppler CSI, a plurality of P/SP-NZP CSI-RS resource sets may be configured, and each NZP CSI-RS resource set may include a plurality of CMRs. The number of CMRs included in each NZP CSI-RS resource set may be the same or may differ. This variation allows a plurality of CMRs to be configured more flexibly. A separation between first CSI-RSs (occasions) in the plurality of NZP CSI-RS resource sets may be the same or may differ. At least one of the operations of Embodiments #1 to #3 may be applied to a plurality of CMRs over a plurality of NZP CSI-RS resource sets.

This embodiment allows a UE to appropriately identify a plurality of CMRs for Doppler CSI reporting in a case where a plurality of NZP CSI-RS resource sets are assumed.

### <Supplements>

### {Notification of Information to UE}

Notification of any information to a UE (from a network (NW) (for example, a base station (BS))) (in other words, reception of any information from the BS in the UE) in the above-described embodiments may be performed by using physical layer signaling (for example, DCI), higher layer signaling (for example, RRC signaling, MAC CE), a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits given to the DCI, a format of the DCI, or the like.

Notification of any information to a UE in the above-described embodiments may be performed periodically, semi-persistently, or aperiodically.

{Notification of Information from UE}

Notification of any information from a UE (to an NW) (in other words, transmission/reporting of any information to the BS from the UE) in the above-described embodiments may be performed by using physical layer signaling (for example, UCI), higher layer signaling (for example, RRC signaling, MAC CE), a specific signal/channel (for example, a PUCCH, a PUSCH, a PRACH, a reference signal), or a combination of these.

When the notification is performed by a MAC CE, the MAC CE may be identified by a new LCID not defined in existing standards being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Regarding Application of Each Embodiment

At least one of the above-described embodiments may be applied to a case satisfying a specific condition. The specific condition may be defined in a standard, or a UE/BS may be notified of the specific condition by using higher layer signaling/physical layer signaling.

At least one of the above-described embodiments may be applied only to a UE that has reported a specific UE capability or that supports the specific UE capability.

The specific UE capability may indicate at least one of the following:
Support of specific processing/operation/control/information for at least one of embodiments above
Support of Doppler CSI based on at least one of enhanced type 2 CSI (Rel. 16) and further enhanced type 2 PS CSI (Rel. 17)

The specific UE capability may be capability applied over all the frequencies (commonly irrespective of frequency), capability per frequency (for example, one or a combination of cell, band, band combination, BWP, component carrier, and the like), capability per frequency range (for example, Frequency Range 1 (FR1), FR2, FR3, FR4, FR5, FR2-1, FR2-2), capability per subcarrier spacing (SCS), or capability per Feature Set (FS) or Feature Set Per Component-carrier (FSPC).

The specific UE capability may be capability applied over all the duplex schemes (commonly irrespective of duplex scheme) or capability per duplex scheme (for example, time division duplex (TDD) or frequency division duplex (FDD)).

At least one of the above-described embodiments may be applied when the UE is configured/activated/triggered with specific information related to the above-described embodiment (or performance of the operation of the above-described embodiment) by higher layer signaling/physical layer signaling. For example, the specific information may be information indicating enabling of the operations of the above-described embodiments, any RRC parameter for specific release (for example, Rel. 18/19), or the like.

When not supporting at least one of the specific UE capabilities or not configured with the specific information, the UE may apply operation of Rel. 15/16, for example.

### (Supplementary Note)

Regarding one embodiment of the present disclosure, the following supplementary notes of the invention will be given.

### {Supplementary Note 1}

A terminal including:
a receiving section that receives a configuration of one or more non-zero power (NZP) CSI-reference signal (RS) resource sets for Doppler channel state information (CSI); and
a control section that determines, based on the configuration, a plurality of periodic or semi-persistent CSI-RS occasions.

### {Supplementary Note 2}

The terminal according to supplementary note 1, wherein the plurality of CSI-RS occasions are associated with at least one of duration of a CSI reporting window, a number of Doppler domain bases, a CSI reference resource, and a separation between the plurality of CSI-RS occasions.

### {Supplementary Note 3}

The terminal according to supplementary note 1 or 2, wherein
the one or more NZP CSI-RS resource sets are a plurality of NZP CSI-RS resource sets, and
the plurality of NZP CSI-RS resource sets each includes a plurality of CSI-RS resources.

### {Supplementary Note 4}

The terminal according to any one of supplementary notes 1 to 3, wherein
the one or more NZP CSI-RS resource sets are one NZP CSI-RS resource set, and
the one NZP CSI-RS resource set includes a plurality of CSI-RS resources.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

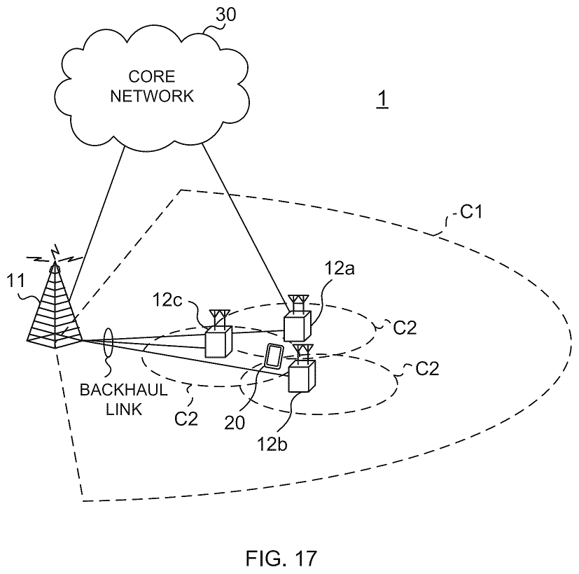

FIG. 17 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR), and so on, whose specifications have been drafted by the Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and the like.

The core network 30 may include network functions (NFs), such as a User Plane Function (UPF), an Access and Mobility management Function (AMF), a Session Management Function (SMF), Unified Data Management (UDM), an Application Function (AF), a Data Network (DN), a Location Management Function (LMF), and Operation, Administration and Maintenance (Management) (OAM), for example. Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) or the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information, and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

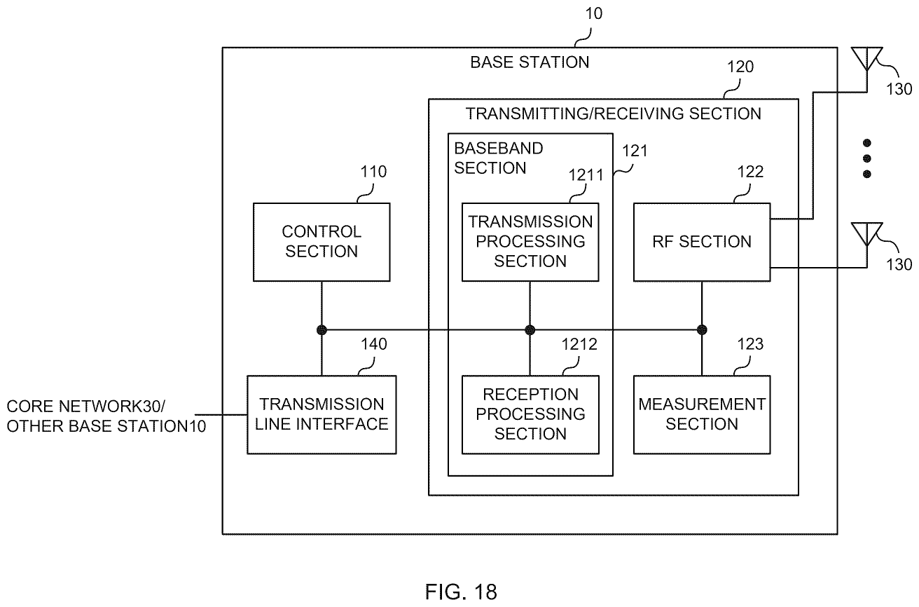

FIG. 18 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam or a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (for example, a network node that provides NFs) included in the core network 30, other base stations 10, and so on, and, for example, acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit a configuration of a channel state information (CSI) report including one or more parameters indicating at least one of a rank indicator restriction and a codebook subset restriction. The control section 110 may cause the one or more parameters to be applied to coherent joint transmission CSI, and may control reception of a report of the CSI.

Note that the transmitting/receiving section 120 may transmit a configuration of one or more non-zero power (NZP) CSI-reference signal (RS) resource sets for Doppler channel state information (CSI). The control section 110 may determine, based on the configuration, a plurality of periodic or semi-persistent CSI-RS occasions.

### (User Terminal)

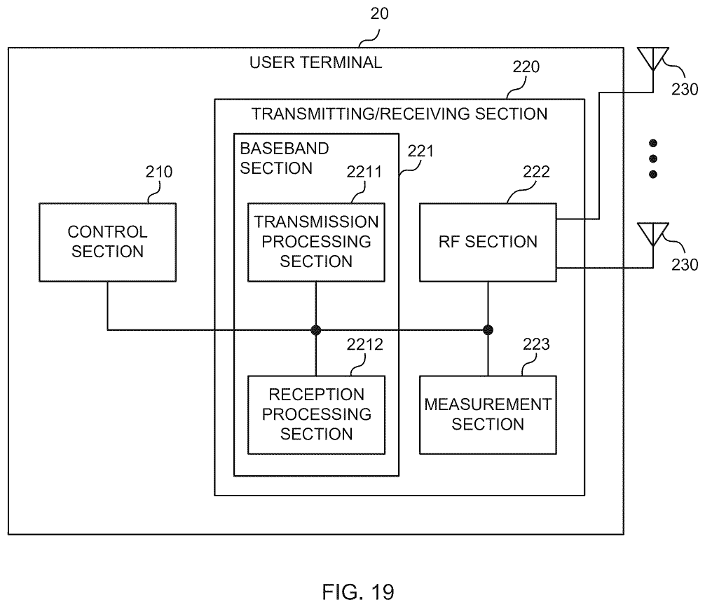

FIG. 19 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure received power (for example, RSRP), received quality (for example, RSRQ, SINR, SNR), signal strength (for example, RSSI), channel information (for example, CSI), or the like. The measurement results may be output to the control section 210.

Note that the measurement section 223 may derive channel measurement for CSI computation, based on a channel measurement resource. The channel measurement resource may be, for example, a non-zero power (NZP) CSI-RS resource. The measurement section 223 may derive interference measurement for CSI computation, based on an interference measurement resource. The interference measurement resource may be at least one of an NZP CSI-RS resource for interference measurement, a CSI-interference measurement (IM) resource, and the like. Note that the CSI-IM may be referred to as CSI-interference management (IM), and may be interpreted as a zero power (ZP) CSI-RS, and vice versa. Note that, in the present disclosure, CSI-RS, NZP CSI-RS, ZP CSI-RS, CSI-IM, CSI-SSB, and the like may be interchangeably interpreted.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive a configuration of one or more non-zero power (NZP) CSI-reference signal (RS) resource sets for Doppler channel state information (CSI). The control section 210 may determine, based on the configuration, a plurality of periodic or semi-persistent CSI-RS occasions.

The plurality of CSI-RS occasions may be associated with at least one of duration of a CSI reporting window, a number of Doppler domain bases, a CSI reference resource, and a separation between the plurality of CSI-RS occasions.

The one or more NZP CSI-RS resource sets may be a plurality of NZP CSI-RS resource sets. The plurality of NZP CSI-RS resource sets may each include a plurality of CSI-RS resources.

The one or more NZP CSI-RS resource sets may be one NZP CSI-RS resource set. The one NZP CSI-RS resource set may include a plurality of CSI-RS resources.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

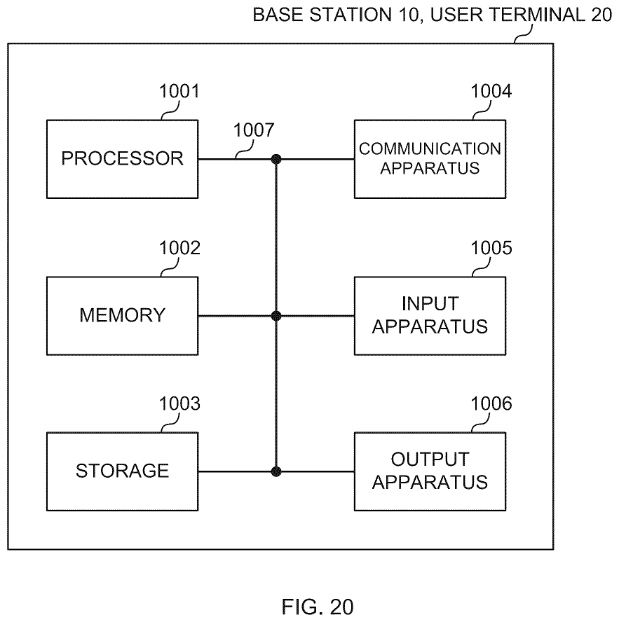

For example, a base station, a user terminal, and so on according to one embodiment of the present disclosure may function as a computer that executes the processes of the radio communication method of the present disclosure. FIG. 20 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### (Variations)

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP (s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, a “layer”, “the number of layers”, a “rank”, a “resource”, a “resource set”, a “beam”, a “beam width”, a “beam angular degree”, an “antenna”, an “antenna element”, a “panel”, a “UE panel”, a “transmission entity”, a “reception entity”, and so on may be used interchangeably.

Note that, in the present disclosure, the “antenna port” may be used interchangeably with an “antenna port for an arbitrary signal/channel” (for example, a demodulation reference signal (DMRS) port). In the present disclosure, the “resource” may be used interchangeably with a “resource for an arbitrary signal/channel” (e.g., a reference signal resource, an SRS resource, and the like). The resource may include time/frequency/code/space/power resource. The spatial domain transmission filter may include at least one of a spatial domain transmission filter and a spatial domain reception filter.

The group may include at least one of, for example, a spatial relationship group, a code division multiplexing (CDM) group, a reference signal (RS) group, a control resource set (CORESET) group, a PUCCH group, an antenna port group (for example, a DMRS port group), a layer group, a resource group, a beam group, an antenna group, a panel group, and the like.

In the present disclosure, a “beam”, an “SRS resource indicator (SRI)”, a “CORESET”, a “CORESET pool”, a “PDSCH”, a “PUSCH”, a “codeword (CW)”, a “transport block (TB)”, an “RS”, and the like may be interchangeably used.

In the present disclosure, a “TCI state”, a “downlink TCI state (DL TCI state)”, an “uplink TCI state (UL TCI state)”, a “unified TCI state”, a “common TCI state”, a “joint TCI state”, and the like may be used interchangeably.

In the present disclosure, “QCL”, “QCL assumption”, “QCL relationship”, “QCL type information”, “QCL property/properties”, “specific QCL type (e.g., type A, type D) property”, “specific QCL type (e.g., type A, type D)”, and the like may be used interchangeably.

In the present disclosure, an “index”, an “identifier (ID)”, an “indicator”, “indication”, a “resource ID”, and the like may be used interchangeably. In the present disclosure, a sequence, a list, a set, a group, a cluster, a subset, and the like may be used interchangeably.

A spatial relation information identifier (ID) (TCI state ID) and spatial relation information (TCI state) may be interchangeably used. “Spatial relation information (TCI state)” may be used interchangeably with “a set of spatial relation information (TCI state)”, “one or a plurality of spatial relation information”, and the like. The TCI state and the TCI may be used interchangeably. The spatial relation information and the spatial relation may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

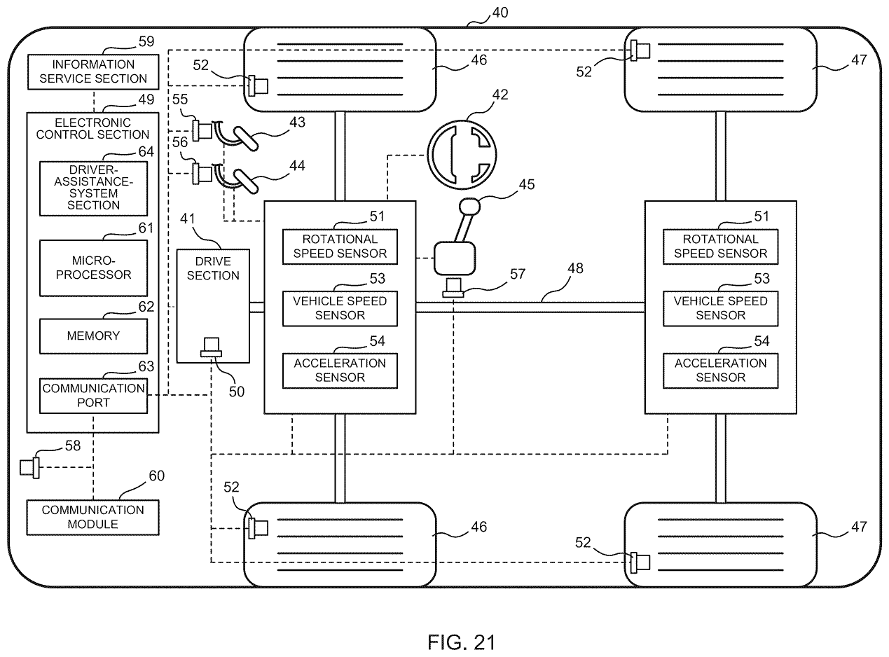

FIG. 21 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions(determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions(determinations)” about resolving, selecting, choosing, establishing, comparing, and so on. In other words, “deciding (determining)” may be interpreted to mean making “decisions (determinations)” about some action. In the present disclosure, “decide/deciding (determine/determining)” may be interchangeably interpreted as the above-described actions.

In the present disclosure, “decide/deciding (determine/determining)” may be used interchangeably with “assume/assuming”, “expect/expecting”, “consider/considering”, and the like. Note that, in the present disclosure, “not expect to” may be used interchangeably with “expect not to”.

In the present disclosure, “expect” may be used interchangeably with “be expected”. For example, “expect(s) . . . ” (“ . . . ” may be expressed using, for example, a that-clause, a to-infinitive, or the like) may be used interchangeably with “be expected . . . ”. “Does not expect . . . ” may be used interchangeably with “be not expected . . . ”. Furthermore, “an apparatus A is not expected . . . ” may be used interchangeably with “an apparatus B other than the apparatus A does not expect . . . for the apparatus A” (for example, when the apparatus A is a UE, the apparatus B may be a base station).

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

In the present disclosure, “when A, B”, “if A, (then) B”, “B upon A”, “B in response to A”, “B based on A”, “B during/while A”, “B before A”, “B (at the same time as)/on A”, “B after A”, “B since A”, “B until A”, and the like may be used interchangeably. Note that A and B here may be replaced with appropriate expressions such as nouns, dynamic nouns, and normal sentences, as appropriate, depending on the context. The time difference between A and B may be substantially 0 (immediately after or immediately before). A time offset may be applied to the time at which A occurs. For example, “A” may be used interchangeably with “before/after the time offset at which A occurs”. The time offset (for example, one or more symbols/slots) may be defined in advance or may be specified by the UE based on the notified information.

In the present disclosure, timing, time point, time, time instance, any time unit (e.g., slot, sub-slot, symbol, subframe), period, occasion, a resource, or the like may be used interchangeably.

Now, although the invention according to the present disclosure has been described in detail above, it is apparent to a person skilled in the art that the invention according to the present disclosure is by no means limited to the embodiments described in the present disclosure. The description of the present disclosure is provided only for the purpose of explaining examples, and should by no means be construed to limit the invention according to the present disclosure in any way.

1. A terminal comprising:
a receiving section that receives a configuration of one or more non-zero power (NZP) CSI-reference signal (RS) resource sets for Doppler channel state information (CSI); and
a control section that determines, based on the configuration, a plurality of periodic or semi-persistent CSI-RS occasions.

2. The terminal according to claim 1, wherein
the plurality of CSI-RS occasions are associated with at least one of duration of a CSI reporting window, a number of Doppler domain bases, a CSI reference resource, and a separation between the plurality of CSI-RS occasions.

3. The terminal according to claim 1, wherein
the one or more NZP CSI-RS resource sets are a plurality of NZP CSI-RS resource sets, and
the plurality of NZP CSI-RS resource sets each includes a plurality of CSI-RS resources.

4. The terminal according to claim 1, wherein
the one or more NZP CSI-RS resource sets are one NZP CSI-RS resource set, and
the one NZP CSI-RS resource set includes a plurality of CSI-RS resources.

5. A radio communication method for a terminal, the radio communication method comprising:
receiving a configuration of one or more non-zero power (NZP) CSI-reference signal (RS) resource sets for Doppler channel state information (CSI); and
determining, based on the configuration, a plurality of periodic or semi-persistent CSI-RS occasions.

6. A base station comprising:
a transmitting section that transmits a configuration of one or more non-zero power (NZP) CSI-reference signal (RS) resource sets for Doppler channel state information (CSI); and
a control section that determines, based on the configuration, a plurality of periodic or semi-persistent CSI-RS occasions.
